(19) United States
(12) Patent Application Publication
(10) Pub. No.: US 2016/0171599 A1
(43) Pub. Date: Jun. 16, 2016

(54) APPARATUS AND METHODS FOR MANAGING DELIVERY OF ITEM INFORMATION AND FACILITATING A SALE OF AN ITEM

(71) Applicants: ERNEST B. BRAY, Escondido, CA (US); ADAM NAZAR, Los Angeles, CA (US)

(72) Inventors: ERNEST B. BRAY, Escondido, CA (US); ADAM NAZAR, Los Angeles, CA (US)

(21) Appl. No.: 14/572,660

(22) Filed: Dec. 16, 2014

(51) Int. Cl. G06Q 30/08

(52) U.S. Cl. CPC G06Q 30/08

(57) ABSTRACT

Apparatus and methods for managing delivery of a plurality of information regarding items for sale and facilitating a sale thereof. In one embodiment, the apparatus comprises a server entity adapted to communicate with item information providers. The server entity compiles the item information received from the item information providers and formats the information for efficient delivery to a plurality of potential buyers. The server enables a sale of salvage items such as salvaged vehicles in one example. The server provides salvage companies with a unified platform to acquire vehicles for salvage, receive information about vehicles in advance and inspect the vehicle itself in-person or virtually via photos or videos before bidding in a salvage auction. In addition, insurance companies are able to provide certification with respect to the current state of the vehicle as a salvageable vehicle. Exemplary client interface and business rules are also given.

### BACKGROUND

1. Technological Field

The disclosure relates to insurance claims processing and managing a collection of salvage offers. In one exemplary aspect, the disclosure relates to processing insurance claims on items such as automobiles, boats, all terrain vehicles, motorcycles, sports vehicles, etc. and then determining a salvage solution.

2. Description of Related Technology

Many damaged or wrecked vehicles, such as automobiles, boats, all terrain vehicles, motorcycles, sports vehicles, etc. come into the possession of private individuals, insurance claim companies and auto-mechanic shops (hereinafter collectively referred to as “companies”). The most common method a company may handle salvaging the vehicle is to call multiple salvage yards individually in an effort to solicit a bid to purchase the damaged vehicle. According to this model, the salvage yards receive very limited and basic verbal information regarding the vehicle, and typically make a decision of whether to purchase the vehicle sight unseen.

In addition, in some instances after a company receives a certain number of“blind bids”, the company elects to either sell the vehicle to the highest offeror or allow the vehicle owner to retain the vehicle. In the scenario where the company allows the vehicle owner to retain the vehicle, a deduction from the final settlement with the vehicle owner may be made.

Alternatively, a company may handle salvage vehicle disposal by contracting with a salvage vendor which manages salvaged vehicles in large geographic regions. Salvage vendors typically offer a percentage of the vehicle value to the company in return for a contract to obtain all the salvaged vehicle losses from that company. The salvage vendor will then pickup the salvaged vehicle from its location, move it to a storage facility, and process the transfer of ownership paperwork in exchange for an agreed upon fee. These large vendors then sell the vehicle parts individually or auction the vehicle on the open market to the general public at a significantly higher price than if purchased directly from the company.

Both of the previously discussed methods lead to inaccurate salvage sales in the claims process. For example, the salvage yard which is purchasing the vehicle is often buying it without knowing the actual value of the vehicle and/or extent of damages. In addition, the companies may lose out on higher salvage sales due to the fact that the salvage yards typically offer conservative amounts to accommodate for the lack of certainty as to the condition of the damaged vehicle.

Accordingly, despite the foregoing systems and methods, there is still a salient need for more efficient, reliable, and timely techniques and apparatus for the delivery of vehicle information. Such improved techniques and apparatus would reliably provide at least the most germane information to a salvage yard, allow for more accurate salvage sales, allow small and medium salvage yards to bid on vehicles, and speed up the insurance claim process. Ideally the improved techniques and apparatus would also be compatible with personal electronics and networking technologies. Still further, exemplary apparatus and technique would be adapted to keep track of a salvage yard's particular vehicles of interest in order to inform and/or alert the salvage yard when vehicles of interest are available or coming up for bidding during an auction, thereby relieving the salvage yard of constantly waiting and watching for their vehicle(s) of interest.

### SUMMARY

The present disclosure addresses the foregoing needs by providing, in various embodiments, methods and apparatus for processing insurance claims and managing a collection of salvage offers via compiled information regarding a plurality of vehicles.

In a first aspect, an apparatus for enabling a real-time auction for salvaged vehicles is disclosed. In one embodiment, the apparatus includes a first interface for communication with a vehicle information source, the vehicle information source comprising a seller of a salvaged vehicle; a second interface for communication with a plurality of salvaged vehicle purchasers; a storage apparatus; and a processor in communication with the storage apparatus and configured to execute at least one computer program thereon, the computer program comprising a plurality of instructions which are configured to when executed by the processor: (i) receive a plurality of information relating to at least one salvaged vehicle for auction; (ii) determine, based at least in part on a profile thereof, individual ones of the a plurality of salvage vehicle purchasers which are to receive a notification relating to the at least one salvaged vehicle for auction; (iii) based on the determination, transmit the notification to the individual ones of the plurality of salvage vehicle purchasers; (iv) receive a plurality of offers to purchase the at least one salvaged vehicle from respective ones of the individual ones of the plurality of salvage vehicle purchasers; (v) enable the vehicle information source to evaluate the plurality of offers and the respective ones of the individual ones of the plurality of salvage vehicle purchasers associated thereto via a user interface provided thereto; and (iv) receive a selection of one of the plurality of salvage vehicle purchasers, the selection indicating acceptance of an offer to purchase the at least one salvaged vehicle by the one of the plurality of salvage vehicle purchasers.

In a second aspect, a method for enabling a real-time auction for salvaged vehicles is disclosed. In one embodiment, the method includes receiving information relating to at least one salvaged vehicle for auction from a vehicle information source, the vehicle information source comprising a seller of a salvaged vehicle; transmitting a notification relating to the at least one salvaged vehicle for auction to individual ones of a plurality of salvage vehicle purchasers based at least in part on a profile thereof; receiving a plurality of offers to purchase the at least one salvaged vehicle from respective ones of the individual ones of the plurality of salvage vehicle purchasers; and receiving a selection of one of the plurality of salvage vehicle purchasers, the selection indicating acceptance of an offer to purchase the at least one salvaged vehicle by the one of the plurality of salvage vehicle purchasers.

In a third aspect, a computer readable apparatus comprising a storage medium, the storage medium comprising at least one computer program is disclosed. In one embodiment, the computer program comprises a plurality of instructions configured to, when executed by a processing apparatus, receive a plurality of information relating to at least one salvaged vehicle for auction; identify, based at least in part on a profile thereof, individual ones of the a plurality of salvage vehicle purchasers which are to receive a notification relating to the at least one salvaged vehicle for auction; transmit the notification to the identified individual ones of the plurality of salvage vehicle purchasers; receive a plurality of offers to purchase the at least one salvaged vehicle from respective ones of the identified individual ones of the plurality of salvage vehicle purchasers; enable the vehicle information source to evaluate the plurality of offers and the respective ones of the identified individual ones of the plurality of salvage vehicle purchasers associated thereto via a user interface; and receive a selection of one of the plurality of salvage vehicle purchasers, the selection indicating acceptance of an offer to purchase the at least one salvaged vehicle by the one of the plurality of salvage vehicle purchasers.

In a fourth aspect, a system for enabling a real-time auction for salvaged vehicles is disclosed.

In a fifth aspect, a consumer premises device (CPE) for enabling a real-time auction for salvaged vehicles is disclosed.

These and other aspects of the disclosure shall become apparent when considered in light of the detailed description provided herein.

Other features and advantages of the present disclosure will immediately be recognized by persons of ordinary skill in the art with reference to the attached drawings and detailed description of exemplary embodiments as given below.

### BRIEF DESCRIPTION OF THE DRAWINGS

FIG. 1 is a block diagram illustrating an exemplary salvage collection (SC) server of the present disclosure.

FIG. 2 is a block diagram illustrating an exemplary system utilizing the SC server of FIG. 1 for efficiently delivering item information and receiving bids.

FIG. 3 is a block diagram illustrating an exemplary SC database for use with the SC server of FIG. 1.

FIG. 4 is a block diagram illustrating an exemplary system utilizing the SC server and SC database of FIGS. 1 and 3, respectively to notify a client of an estimated time when an item will begin being bid on.

FIG. 5 is a logical flow diagram illustrating an exemplary method of employing the SC server of FIG. 1 to efficiently deliver item information and obtain bids on an item.

FIG. 6a is a logical flow illustrating an exemplary method of utilizing the SC server to efficiently process a claim.

FIG. 6b is a logical flow illustrating an exemplary method of efficiently deliver item information and obtain bids on an item.

FIG. 6c is a logical flow illustrating an exemplary method of efficiently deliver item information and obtain bids on an item.

FIG. 7a is a graphical representation of an exemplary interface for enabling a client to input and review submitted items.

FIG. 7b is a graphical representation of an exemplary interface for enabling a salvage source to submit a bid on an item.

FIG. 7c is a graphical representation of an exemplary interface for enabling a salvage source to view a bid on an item

FIG. 7d is a graphical representation of an exemplary interface for enabling a client to view transaction details on an item.

FIG. 7e is a graphical representation of an exemplary interface for enabling a salvage source to review items of interest and submitted bids on an item.

FIG. 7f is a graphical representation of an exemplary interface for enabling a salvage source to review an item

FIGS. 7g-7j are graphical representations of exemplary interfaces for enabling a client to select a winning bid and review transactional details on an item.

FIG. 8 is a logical flow diagram illustrating an exemplary method of monitoring an ongoing bidding according to the present disclosure.

FIG. 9 is a logical flow diagram illustrating another exemplary method of monitoring an ongoing bidding according to the present disclosure.

FIG. 10 is a logical flow illustrating an exemplary method of employing the SC server of FIG. 1 to efficiently place payment into escrow and process the purchase of an item.

### DESCRIPTION OF THE DISCLOSURE

Reference is now made to the drawings listed above, wherein like numerals refer to like parts throughout.

As used herein, the term “application” refers generally to a unit of executable software that implements theme-based functionality The themes of applications vary broadly across any number of disciplines and functions (such as e-commerce transactions, shipping transactions, entertainment, calculator, Internet access, etc.), and one application may have more than one theme. The unit of executable software generally runs in a predetermined environment; for example and without limitation, the unit could comprise a downloadable Java Xlet™ that runs within the JavaTV™ environment.

As used herein, the terms “client device,” “terminal,” “personal electronic device” (PED) and “user device” include, but are not limited to, personal computers (PCs), whether desktop, laptop, or otherwise, personal digital assistants (PDAs) such as the “Palm®” family of devices, cellular or “smart” phones such as the Apple iPhone, handheld computers, J2ME equipped devices, personal media devices, set-top boxes, or literally any other device capable of interchanging data with a network. Such devices may interface using wired or optical fiber mechanisms such as an IEEE Std. 802.3 Ethernet interface, Digital Subscriber Line (DSL), DOCSIS modem, hybrid fiber-coax (HFC) cable, FireWire (IEEE Std. 1394), or alternatively via wireless mechanisms and protocols such as 3GPP/3GPP2, Bluetooth™, IrDA interface, IEEE Std. 802.11, UWB (e.g., IEEE-Std. 802.15 or similar), WiMAX (802.16), Wireless Application Protocol (WAP), GPRS, GSM, or any other of myriad data communication systems and protocols well known to those of skill in the communications arts.

As used herein, the term “computer program” is meant to include any sequence of human or machine cognizable steps which perform a function. Such program may be rendered in virtually any programming language or environment including, for example, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.) and the like.

As used herein, the term “database” refers generally to one or more tangible or virtual data storage locations, which may or may not be physically co-located with each other or other system components.

As used herein, the term “digital processor” is meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable compute fabrics (RCFs), array processors, and application-specific integrated circuits (ASICs). Such digital processors may be contained on a single unitary IC die, or distributed across multiple components.

As used herein, the term “display” means any type of device adapted to display information, including without limitation CRTs, LCDs, TFTs, plasma displays, LEDs, and fluorescent devices.

As used herein, the term “memory” includes any type of integrated circuit or other storage device adapted for storing digital data including, without limitation, ROM, PROM, EEPROM, DRAM, SDRAM, DDR/2 SDRAM, EDO/FPMS, RLDRAM, SRAM, “flash” memory (e.g., NAND/NOR), and PSRAM.

As used herein, the term “network” refers generally to data or communications networks regardless of type, including without limitation, LANs, WANs, intranets, internets, the Internet, cable systems, telecommunications networks, satellite networks, and Virtual Private Networks (VPNs), or collections or combinations thereof, whether based on wired, wireless, or matter wave modalities. Such networks may utilize literally any physical architectures and topologies (e.g. ATM, IEEE-802.3, X.25, Token Ring, SONET, 3G/3GPP/UMTS, 802.11, 802.16, 802.15, Hybrid fiber-coax (HFC), etc.) and protocols (e.g., TCP/IP, HTTP, FTP, WAP, GPRS, RTP/RTCP, etc.).

As used herein, the term “service provider” refers generally to services provided remotely to the user including, for example, data streaming, data analysis, financial account management and trading, data archiving and storage, Internet access, content delivery, telecommunications, etc.

As used herein, the term “speech recognition” refers to any methodology or technique by which human or other speech can be interpreted and converted to an electronic or data format or signals related thereto. It will be recognized that any number of different forms of spectral analysis (such as MFCC (Mel Frequency Cepstral Coefficients) or cochlea modeling, may be used. Phoneme/word recognition, if used, may be based on HMM (hidden Markov modeling), although other processes such as, without limitation, DTW (Dynamic Time Warping) or NNs (Neural Networks) may be used. Myriad speech recognition systems and algorithms are available, all considered within the scope of the disclosure disclosed herein.

As used herein, the term “vehicle” refers to any form of air, land or water transportation for either person, animals, and/or inanimate objects including, without limitation, buses, cars, sports utility vehicles, all terrain vehicles, motorcycles, boats etc.

### Overview

The present disclosure provides, inter alia, methods and apparatus for enabling a real-time auction for a plurality of items is given. In one embodiment, an apparatus receives a plurality of information relating to at least one item for auction. The plurality of information is sent by a client via a client device. The plurality of information includes identification information (such as a vehicle identification number (VIN) or an insurance claim number (ICN)), item descriptive information (such as make, model, year, etc.), and/or damage description information (including photos and/or videos demonstrating the extent of damage). The apparatus then determines based at least in part on a profile thereof, individual ones of a plurality of salvage vehicle purchasers which are to receive a notification relating to the at least one item for auction. The profile is created when each one of the plurality of salvage vehicle purchasers creates an account to be notified for real-time auction opportunities. In one variant, the profile information may include a subscription level, or preferences such as (i) geographic parameters; (ii) item types; and/or (iii) an items cost. The apparatus then based on the determination, transmits the notification to the individual ones of the plurality of salvage vehicle purchasers. The apparatus receives a plurality of offers to purchase the at least one item from respective ones of the salvage vehicle purchasers. The apparatus then enables an item information source to evaluate the plurality of offers. In one variant, the apparatus also enables the item information source to evaluate in addition to the plurality of offers, the respective ones of the individual ones of the plurality of salvage vehicle purchaser associated thereto, via a user interface. The apparatus then receives a selection of the bid that is the winning bid. The apparatus then transmits a notification to the salvage vehicle purchaser associated to the winning bid that the salvage vehicle purchaser bid for the particular item was accepted and selected as the winning bid.

Methods of operating the network(s), client devices, and for doing business using the network referenced above, are also described.

### DESCRIPTION OF EXEMPLARY EMBODIMENTS

It is noted that while the system and methods of the disclosure described herein are discussed with respect to delivery of information regarding vehicles to be salvaged, certain aspects of the disclosure may be useful in other applications, including, without limitation, other types of items to be salvaged, such as those for chattel (including e.g., electronics or other such items) and/or undamaged or unused items for sale or auction.

### Salvage Collection (SC) System—

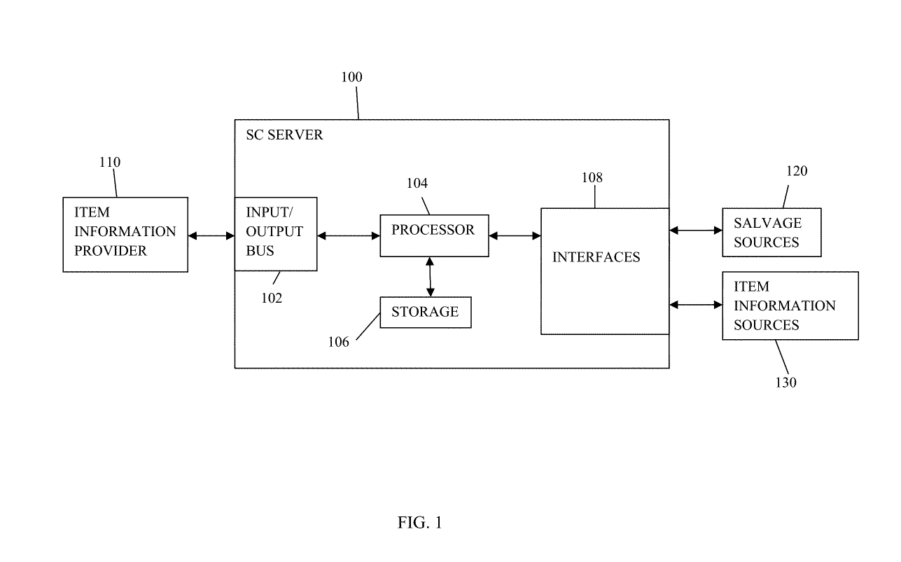

One salient feature of the present disclosure is the utilization of one or more Salvage Collection (SC) servers. An exemplary SC server 100 is illustrated in FIG. 1. As shown, the SC server 100 generally comprises an input/output bus 102, a storage device 106, a digital processor 104 and a plurality of interfaces 108 for communication to other devices via one or more networks. Although illustrated as a single device, it is appreciated that the SC server 102 may comprise any number of distinct devices and form factors.

In the illustrated embodiment, the input/output bus 102 of the SC server 100 is the subsystem for data transfer into and out of the SC server 100. For example, data in the form of a request may be transferred into the SC server 100 from one or more item information providers 110 (such as a client device into which a user has input the data). In one variant, the user of the client inputs information relating to an item for sale, which is uploaded to the SC server 100. The information may include e.g., vehicle specific information (such as VIN or other identifier), claim specific information (such as an insurance claim number (ICN)), vehicle descriptive information (such as make, model, year, etc.), and/or damage description information (including photos and/or videos demonstrating the extent of damage). The damage description information may alternatively identify only those portions of the vehicle that remain useable or re-salable. For example, a vehicle having total body loss may list only the portions of its engine that are resalable. A prepopulated list of vehicle parts may be useful in accomplishing the foregoing; such a list may be prepopulated based on e.g., a user's entry of the vehicle description information. For example, when it is known that a salvage car comprises a BMW 330i, the SC server 100 or other entity which generates the interface into which the client device enters the vehicle information pre-populates the car part list for the user, who may then select or mark the condition or status of each part. The car part list may have any level of granularity and may telescope such that an indication that e.g., the car's engine contains salvageable parts would cause generation of a new list seeking specific information about the particular engine parts, and so on.

In another embodiment, the item information provider 110 may, in addition to or as an alternative to inputting the foregoing data manually, instead use a camera function of a client device to take a picture of the data. In another alternative, a scanner may be utilized (such as a bar code or quick response (QR) code scanner). The client device may additionally utilize an optical character recognition program (such as GOCR, JOCR, etc.) to convert a pictured image to alpha-numeric text, the text is then sent to the SC server 100.

The item information is processed and/or formatted for storage and subsequent transmission and searches. The processing and/or formatting may comprise parsing the received data so that it may be provided in a summarized format to the salvage sources 120. That is, an initial presentation of data to a salvage source 120 may comprise only portions of the entire data collected about an item (such as a vehicle). The salvage sources 120 may enter further communications with the SC server 100 to obtain more detailed information, such as information specific to its particular goals/needs. In yet another embodiment, the information provided from the information provider 110 client device may be made searchable. According to this variant, a salvage source 120 may query the SC server 100 to determine whether a specific vehicle type or part (e.g., an automatic diming rearview mirror for a BMW) is available.

The item information is then transferred out of the SC server 100 to one or more salvage sources 120 via the interfaces 108. As will be discussed in greater detail below, the interfaces 108 may be further configured to request and receive information from other information sources 130.

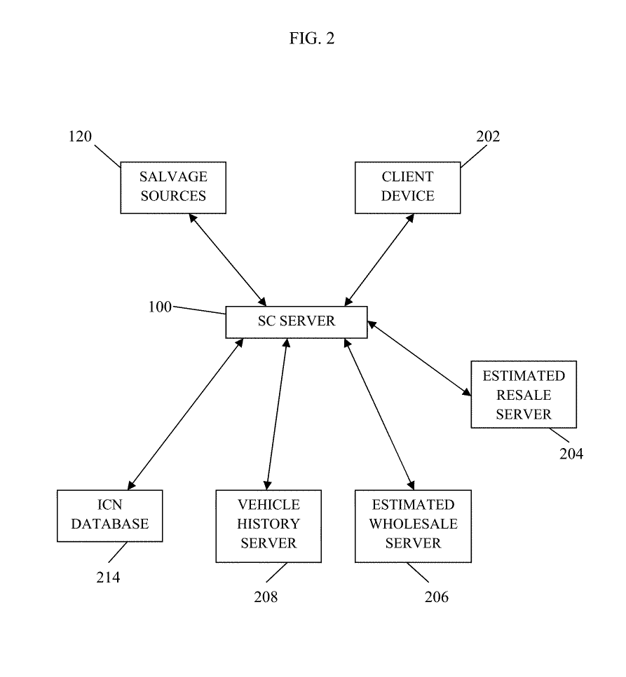

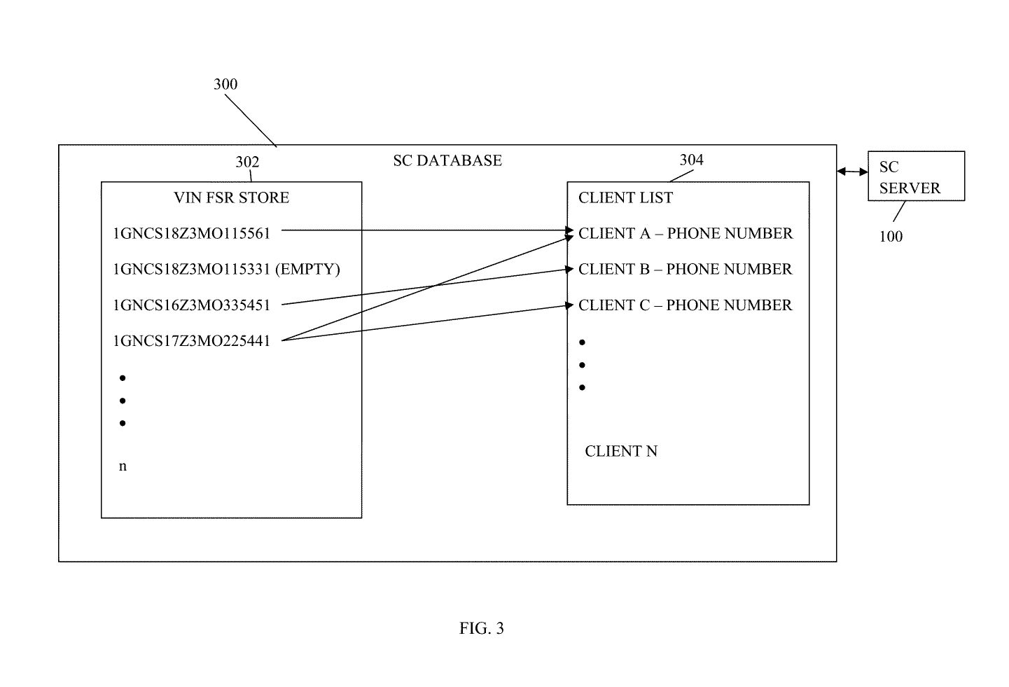

The storage device 106 of the SC server 100 is adapted to store processed and formatted item information. In one embodiment, the items may comprise vehicles and the processed and formatted item information may be stored and sortable by vehicle VIN number (see e.g., the VIN embodiment discussed below with respect to FIG. 2). In another embodiment, items are referenced by insurance claim number (ICN), which will be discussed in greater detail below (see e.g., the ICN embodiment discussed below with respect to FIG. 3). In addition, the ICN may be cross-referenced to a VIN such as for providing auction services for salvaged items. Still further, as discussed above, the storage apparatus 106 may be further configured to enable specific vehicle type and/or part searches.

As illustrated, the SC server 100 further comprises a digital processor 104, which, in one embodiment, is configured to run one or more computer programs (stored at the storage apparatus 106), the computer programs are configured to cause the SC server 100 to obtain information from an information provider 110 (such as via generation of an interactive interface). Additionally, the one or more computer programs may enable the SC server 100 to generate requests to various item information servers (not shown) as well as format data received from item information servers 130 and item information providers 110 into data which is more efficiently transmitted and more easily displayed at the salvage sources 120 (such as by client devices associated therewith) and/or which is searchable. In another embodiment, the computer programs are configured to cause the SC server 100 to transmit the data received from the item information provider 110 to the salvage sources 120, such as in the form of a GUI. Other functions of the digital processor 104 and/or other computer program-implemented functionality will be discussed in detail below as well.

Exemplary item information servers include, inter alia, estimated resale servers, estimated wholesale servers, auction identifier databases, auction servicer servers, and/or vehicle history servers for situations involving the auction of vehicles. Formatting may, in one embodiment, comprise summarizing and/or presenting only portions of the data received so as to generate a message which is most germane or suitable (i.e., simple or small enough) for transmission to the salvage sources 120 via text or other messaging in a timely and reliable manner.

It is also appreciated that the methods of the present disclosure may be practiced using any configuration or combination of hardware, firmware, or software, and may be disposed within one or any number of different physically or logically distinct entities. Myriad different configurations for practicing the disclosure will be recognized by those of ordinary skill in the art given the present disclosure.

The SC server 100 can also be masked or controlled by a “business rules engine” or other logical wrapper or layer as described subsequently herein.

### Salvage Collection Network—

In one embodiment of the present disclosure, the SC server 100 enables a sale of salvage items such as vehicles. The sales may comprise multi-party online or in-person auctions, and/or direct sales (e.g., consumer-to-consumer, business-to-consumer, consumer-to-business and/or business-to-business sales) or one or many salable items. In addition, the SC server 100 provides a plurality of salvage sources 120 with a unified platform in which a salvage company may acquire vehicles for salvage, receive information about vehicles in advance and inspect the vehicle itself in-person or virtually via photos or videos before bidding in a salvage auction. In addition, insurance companies are able to provide certification with respect to the current state of the vehicle as a salvageable vehicle.

As shown in FIG. 2, the SC server 100 receives a plurality of information regarding an item for sale from a client device 202 associated with an information provider 110. Generally, the information regarding the item for sale relates to a damaged vehicle to determine salvage solutions. The client in this embodiment may comprise an insurance adjuster or other insurance company representative, a field appraiser, and/or a repair facility personnel. In another embodiment, the client may be a private individual.

As will be discussed in greater detail below, the information provider 110 may input information including: damage description information, vehicle description information, vehicle specific information, and/or claim specific information. In the instance the client is a representative of the insurance company associated to the salvaged vehicle, the present disclosure has the added advantage of ensuring that the salvaged item is certified by the insurance company as e.g., a total loss vehicle. Although illustrated and described in terms of web-based messaging, it will be appreciated that communication to and from the client device 202 and/or other entities may occur via any number of mechanisms including, inter alia, web-based instant messaging, SMS-based text messaging, or the like.

The client uses a client device 202 to further enter digital images of the damage to the vehicle (or other item). Additional item information may also be entered including e.g., an estimate of repairs and identifying information pertaining to the specific item or vehicle. Exemplary vehicle information may include: year, make, model, body, series, color, mileage, type (car, truck, van, sedan, etc.), dealer stock number, interior color, all vehicle options, actual cash value, retail sticker price, sales price, where/how the vehicle was previously sold (e.g. retail, physical wholesale auction, wholesale through brokers, AAX wholesale), date the vehicle was purchased, date the vehicle was sold, who purchased the vehicle, who sold the vehicle, previous service and repair costs, part costs, other reconditioning costs, etc.

It is appreciate that in addition to the foregoing data provision methods, the client may further input textual information about the vehicle (such as ICN, VIN number, etc.) using a camera function of the client device 202, such as to take a picture of the VIN number, scan a bar code, etc. The client device 202 will then utilize the optical character recognition program (such as GOCR, JOCR, etc.) to convert the pictured image to alpha-numeric text, the text is then sent to the SC server 100 as discussed above. The VIN, ICN and/or other information about the vehicle may also be represented by one or more bar codes or QR codes, which are scanned by the client device 202.

In another embodiment, one or more of the vehicle specific and/or claim specific information may be provided to third party servers such as e.g., the illustrated ICN database 214, vehicle history server 208, estimated wholesale server 206, and/or estimated resale server 204 to arrive at e.g., a portion of the foregoing data descriptive of the item for sale. In one specific example, an ICN number is input from the client device 202 to the SC server 100, which then transmits queries the ICN database 214 to determine a vehicle identifier (VIN) as well as certain insurance information. The ICN is a specific insurance claim identifier comprised of numbers and/or letters depending on the specific insurance company.

The VIN number is then sent in a request to various item information servers 130, including, inter alia, an estimated resale server 204, an estimated wholesale server 206, and/or an estimated vehicle history server 208; however alternate servers adapted to transmit information regarding used items may also be used consistent with the present disclosure. These entities may also be integrated into one unified server, or any combinations thereof. The item information servers 130 return detailed reports to the SC server 100.

In one example, the estimated resale 204 and wholesale 206 servers provide estimated value reports (EVR) to the SC server 100 in response to a request therefor. In one embodiment, the EVR of the estimated resale server 204 includes an estimate of the amount a client may expect to be able to sell the vehicle for as salvaged based on e.g., the amount and extent of damages if known. The EVR of the estimated wholesale server 206 includes an estimate of the amount the salvage source 120 may expect to pay wholesale for the vehicle as salvaged based on e.g., the amount and extent of damages if known.

The vehicle history server 208, upon the SC server 100 request will retrieve a vehicle history report (VHR). In one embodiment, the vehicle history server 208 may be configured to return history reports generated by, inter alia, a department of motor vehicles, Autocheck™ CarFax™, or generated by any number of web-based servers such as, inter alia, isitalemon.com, eztitlesearch.com, ebay.com, cardectective.com, Gov-Reports.com, etc. Generation and distribution of vehicle history reports is well known in the art and will not be discussed in further detail herein.

The SC server 100 is adapted to receive and compile information received from the client device 202 and, if appropriate, any reports received from the various servers 204, 206, 208, 210, and/or 214 (including, inter alia, EVR, VHR, etc.). One or more computer applications executed by the processor 104 of the SC server 100 direct the formatting of the received information into a format that is suitable for transmission to the salvage sources 120 (e.g., web site or web-based messaging), termed a formatted salvage report (FSR). In one embodiment, the FSR is duplicated and one copy is sent for storage at an SC database (not shown), which will be discussed in greater detail below and the other is sent to the salvage sources 120. Various business rules relating to the transmission of an FSR will be discussed in greater detail below. Additionally, the client receive a copy of the FSR for its records via e.g., inputting the VIN or the ICN number.

Once the information is collected and distributed, the salvage sources 120 submit bids or offers to the SC 100 for a particular salvage vehicle. The bids may include such information as the name of the salvage company, phone number, contact person's name, alternative methods to contact (e.g., mobile phone or email), and/or location of the company. A client, such as an insurance company associate, is provided with the bids for review thereof and may select a bid. The selection is transmitted to the SC server 100, which negotiates the purchase the vehicle. The SC server 100 notifies the “winning” salvage yard 120. The salvage yard 120 then may complete any necessary paperwork to take possession of the vehicle via through the SC server 100. The SC server 100 may additionally receive payment from the salvage sources and forwards the payment to the client device 202 or the item information provider 110.

It is appreciated that other forms of entry may also be utilized including e.g., speaking or saying the VIN or ICN into a client device capable of recognizing and translating the speech to text. For instance, a speech recognition algorithm may be resident within the program memory of the client device 202, and in conjunction with a microphone, convert received analog signals from a user (e.g., a VIN, ICN, or vehicle descriptive information) into a digital representation thereof, which is then used to populate an appropriate FSR. Such speech recognition algorithms and systems are well known in the art, and accordingly not described further herein. In yet another embodiment, the speech recognition system may be implemented at a device associated with the salvage sources 120, the SC server 100, or any other entity of the herein described disclosure.

### Salvage Collection (SC) Database—

An exemplary SC database 300 is illustrated in FIG. 3. The SC database 300 may be stored at the storage entity 106 of the exemplary SC server 100 or, in another alternative, be in communication with the server 100 yet comprise a separate entity therefrom.

In the illustrated embodiment, the SC database 300 generates a list of VIN numbers (or other item identifier) and stores a plurality of information relating thereto (such as e.g., vehicle description information, damage description information, and/or claim specific information) as an FSR for each VIN in a VIN FSR store 302. It is also appreciated that, in another embodiment (not shown), the SC database 300 may store item information using the ICN number as a unique identifier of the item.

As salvage sources 120 request information for one or more of the items based on VIN numbers or other searchable aspect, the database creates a client list 304. The client list 304 lists each salvage source 120 by a name (e.g., “Client A”, “Client B”, “Client C”), telephone number and/or account number. As shown, any information stored in the database 300 may be provided to any one of the salvage sources 120 via delivery thereof to the listed contact information (including e.g., telephone number, email address, etc.).

As illustrated in FIG. 3, the VIN FSR store 302 first creates a list of all VIN numbers (or other identifiers) for each item available (such as for sale or auction). One of the salvage sources 120 requests information about the item by sending to the SC server 100 the VIN number (see also ICN and/or other search term embodiments discussed above). In another alternative, the salvage sources 120 may not actively request information about specific vehicles, but instead may subscribe to a service in which the SC server 100 pushes information to the source 120 based on previously entered criteria. For example, a specific source 120 may request to be notified any time a BMW is available within e.g., the next six months. According to this embodiment, an operator at the salvage source 120 will receive information about certain vehicles without user intervention or specific request therefor. In another variant, a user may subscribe to a broader level of service such as to be updated any time any vehicle becomes available, or to be periodically updated of all available vehicles (such as daily, weekly, monthly, etc.). Again, in the foregoing embodiments, a user or operator of a device at the specific source 120 need not specifically request information, yet will be provided with vehicle information (such as a summary or condensed version of the collected data and/or FSR).

As discussed above, the SC server 100 will take appropriate action to retrieve information (such as from an information provider 110 and/or information sources 130) and format the information into an FSR. One copy of the FSR is sent to the salvage source 120, and the other copy is pushed to the SC database 300 for storage in the VIN FSR store 302 according to the VIN which it relates. The SC database 300 also creates an entry in the client list 304 for the particular salvage source 120 requesting the information and links the VIN FSR entry to the salvage source entry to be used for billing and/or other purposes.

For example, suppose Client A requests information about items 1GNCS18Z3MO115561 and 1GNCS17Z3MO225441. When generated, the FSR will be placed in the VIN FSR store 302 for each of the VIN and linked to a client entry for Client A. Then, when Client B requests information about item 1GNCS16Z3MO335451, the database 300 will search the VIN FSR store 302 to determine whether an FSR has previously been generated. The database 300 “knows” if one has been generated by determining whether the entry is empty or not. In the case of item 1GNCS16Z3MO335451, Client A had not previously requested information regarding that item. Thus, the entry is empty and the SC server 100 will be triggered to begin generating an FSR (as discussed elsewhere herein), once completed one copy will be stored in the VIN FSR store 302 and Client B will be entered into the client list and linked to the VIN FSR store 302 entry. Client C then requests information about item 1GNCS17Z3MO225441 (which was previously requested by Client A). The database 300 determines that the entry contains the FSR and thus copies it and forwards the copy to Client C, while also linking Client C to the VIN FSR 302 entry.

Similarly, the clients may request and receive summarized item information and participate in communications requesting only certain portions of the FSR. Also, as noted above, the foregoing may occur in the absence of specific user requests for each vehicle FSR (and instead delivery of the FSR or a portion or summary thereof is automatic).

### Reminders/Alerts and Time Estimates—

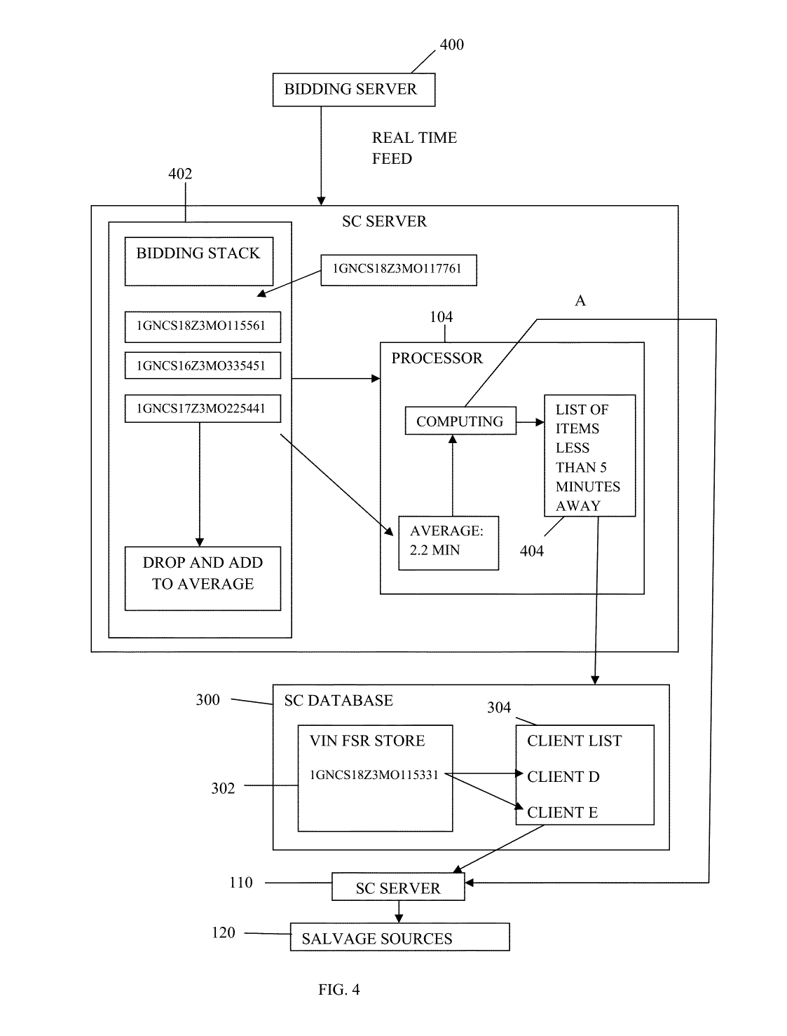

Referring now to FIG. 4, an embodiment is described wherein the SC server 100 is configured to communicate to the salvage sources 120 a time at which previously selected items are estimated to open and/or close bidding.

The SC server 100 may communicate time estimates, reminders, and/or alerts in various situations. For example a reminder/alert may be sent upon a salvage user's selection to be reminded/alerted, e.g., at the time of viewing a received FSR, the salvage source 120 selects to be reminded/alerted when bidding on this item will be accepted (e.g., a start and/or end date/time for bidding), the reminder or alert may be send in advance of a beginning or closing of bidding (e.g., five minutes in advance). In addition, estimates may be sent (upon a salvage user's request) indicating an approximate time at which bidding for a specific item may open or close, e.g., by sending an SMS message to the SC server 100 stating the command “time” or “time estimate” or the like, and some information identifying the item (such as a photograph, the ICN, or VIN). The time estimate may be further based on the value of bids received. For example, if an estimated value of an item is $3000, the time estimate alert may be sent when a bid for $3000 or more is received. That is, the system may estimate that bidding will close shortly after someone has bid at or near the estimated value. It is also appreciated that the client may select a time prior to the beginning or ending of bidding to receive reminders/alerts and/or that the salvage source 120 may choose to receive a reminder/alert even after having been given a time estimate.

As illustrated in FIG. 4, the SC server 100 is adapted to receive a real time feed from a bidding server 400 (or other server providing updated information regarding the sale of items). The bidding server 400 provides updates as to a time for which bidding on an item is open and/or closed. This information is added to a bidding time stack 402 in the SC server 100. The bidding time stack 402 is averaged after each new sale time addition and the averaged information is used to compute a dynamic list 404 of items that are estimated to be less than a set number of minutes away from beginning and/or ending sale. In the exemplary embodiment, the processor 104 uses 5 minutes, however longer or shorter periods may be utilized consistent with the present disclosure, and may in fact be varied as a function of the then-prevailing situation or dynamics of the bidding (e.g., two minutes for anything in Lane 2, five minutes for anything in Lane 4, etc.).

The information held in the dynamic list 404 is then compared (such as by ICN or VIN number) to the FSR list 302 at the SC database 300, in order to determine if any salvage sources 120 have shown interest in the items for which bidding will begin shortly. The dynamic list 404 may also be compared to other database 300 lists (not shown) including lists for those salvage sources 120 who have specifically requested a reminder/alert regarding particular items.

In the illustrated example of FIG. 4, Client D is linked to item 1GNCS17Z3MO225331, and Client E is also linked to item 1GNCS17Z3MO225331. Thus, when item 1GNCS17Z3MO225331 appears on the list of items less than 5 minutes away, the SC server 100 sends an alert or reminder such as via text or other message to the salvage sources 120 of Clients D and E indicating that bidding is soon to begin for that item.

In a situation where at least one of the salvage sources 120 has requested a time estimate, via pathway A, the processor 104 computes, based in part on the averages determined from the bidding time stack 402, when bidding on that particular item should begin (or end) and reports that to the salvage sources 120.

In one embodiment, the bidding server 400 gives periodic updates as to the remaining time for biding on each item.

### Exemplary Operation—

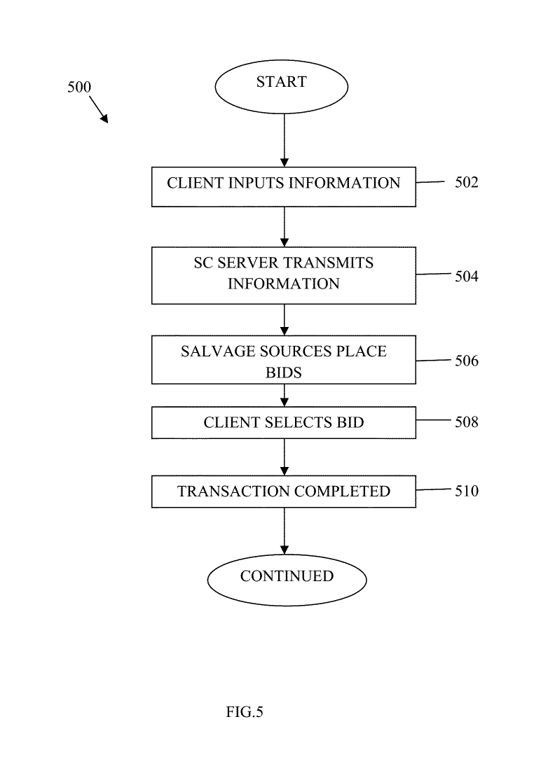

An exemplary method 500 of employing the SC server 100 of the present disclosure to obtain multiple bids on an item is now described with respect to FIG. 5. As illustrated, at step 502, the client sends information about the item to the SC server 100. In one embodiment, the client inputs the information via the client device 202 to the SC server 100. The information inputted by the client may include without limitation, the claim number, which may comprise of an alphanumeric number and/or the insurance company name, the year of the vehicle, the make and model of the vehicle, the mileage of the vehicle, the location of the vehicle, the date of loss, the VIN number, the estimated dollar amount, a full repair estimate, which may comprise a copy of the estimate from a auto-mechanic repair shop, digital photographs of the vehicle, and/or video of the vehicle. As noted above, in another embodiment, damage description information may identify only those portions of the vehicle that remain useable or re-salable. This may be entered via a user's selection of one or more items on a prepopulated list of vehicle parts; such a list may be generated based on e.g., a user's entry of the vehicle description information.

In another embodiment, the client submits a VIN number or an ICN number to the SC server 100. In this embodiment, the SC server 100 then queries one or more item information servers 130, as described above, to retrieve descriptive information about the item, such as year, make model, mileage, estimate dollar amount etc. In addition, the SC server 100 may receive additional information such as a vehicle history report and/or estimated resale value.

Per step 504, the SC server 100 formats the information into a report (such as an FSR) and transmits at least a portion of the report to participating salvage sources 120. In one embodiment, the participating salvage sources 120 pay a subscription fee. In another embodiment, the report transmitted to the salvage sources 120 is a summary of the information with an option to purchase a full report from the SC server 100. As noted above, informational reports may be provided according to previously agreed upon rules (such as all BMW, all vehicles updated daily, weekly, etc.).

Per step 506, one or more of the salvage sources 120 submits a bid to the SC 100. The bids are received and entered in real time and may include such information as the name of the salvage yard, phone number, contact person's name, alternative methods to contact (e.g., mobile phone or email), and/or location of the yard.

At a pre-designated “closing” time for the bidding, at step 508, the client reviews the bids and selects the best offer to purchase the item. The client may choose the best offer based on the best offer price, past experience with a particular salvage yard, grading of service provided, and other such parameters as best services, vehicle data, distance from the client.

Per step 510, the transactions are completed. In one embodiment, the salvage yard purchases the item from the client, completes any necessary paperwork and takes possession of the item via direct communication between these entities. In another embodiment, the SC server 100 further facilitates the exchange of payment (i.e., the client receives payment for the item less any storage costs). The information of the payment transaction is stored in a profile for that particular salvage source 102 and accessed when transfer of possession of the item is scheduled to occur.

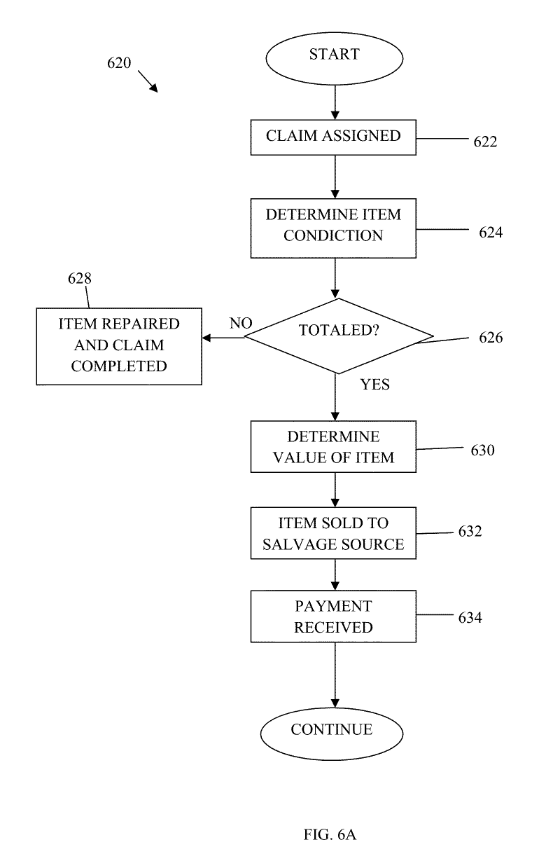

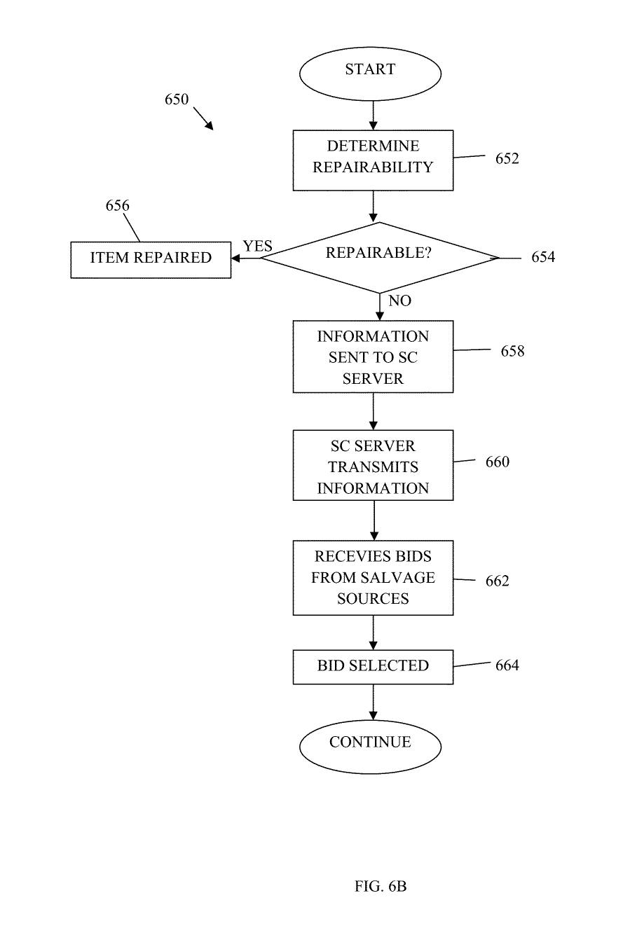

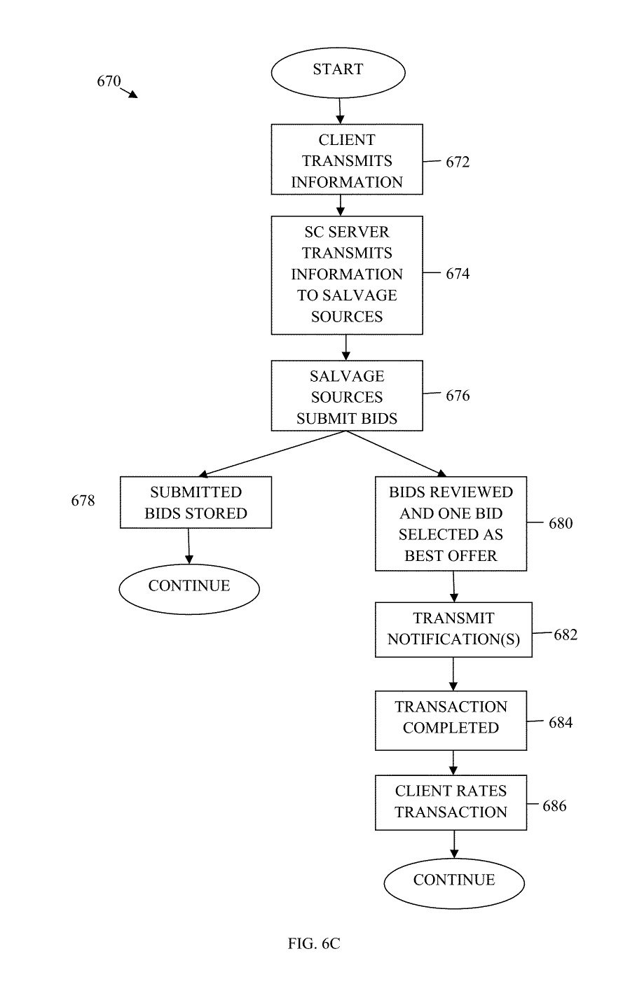

Referring now to FIG. 6a, another embodiment of a method 620 of employing the SC server 100 of the present disclosure to complete an insurance claim is described. The method 620 comprises at step 622 assignment of a claim to at least one of: an auto-mechanic repair shop, an insurance staff field representative, and/or an independent appraiser. Per step 624 the client assigned to the item determines the damage of the item and whether the item is a total loss (i.e., totaled) or is reparable. When it is determined (step 626) that the item is repairable, then the item is repaired and the insurance claim is completed per step 628. Fulfillment of insurance claims with respect to payment for repairs is well-known and thus will not be discussed in further detail herein.

When it is determined (step 626) that the item is a total loss then the actual cash value of the item and the salvage value is determined per step 630. Actual cash value of the item is determined, in one embodiment via consultation to third party sources. In another embodiment, the total loss value is determined via consultation to third party sources. In one embodiment, the third party sources provide a total loss evaluation, which includes comparable vehicle analysis obtained through current similar items for sale through item information sources 130, such as, autotrader.com, cars.com, National Automobile Database Association (NADA), Kelly Blue Book, etc.

Next per step 632, the item is sold to a salvage yard for disposal. In one embodiment, multiple bids are submitted and the client chooses the best offer based on offer price and/or experience with a particular salvage yard. In another embodiment, the client contacts individual salvage yards to receive bids or to sell directly to the salvage yard. Next per step 634, the client receives payment for the item less any storage costs, thus completing the insurance claim.

FIG. 6b illustrates yet another embodiment of an exemplary method 650 of employing the SC server 100 of the present disclosure to obtain multiple bids on a vehicle and complete an insurance claim. The method 650 comprises at step 652 determining if the damage to the vehicle is repairable. In one embodiment, the vehicle is brought to an auto-mechanic shop and a repair-person determines the damage to the vehicle. Alternatively, an insurance company's field representative or an independent appraiser may determine the extent of the damage to the vehicle. When it is determined (at step 654) that the vehicle is repairable, then the vehicle is brought to an auto-mechanic shop where the vehicle is repaired and the insurance claim is completed (step 656). When it is determined (at step 654) that the vehicle cannot be repaired (i.e., total loss), then information regarding the vehicle is sent to the SC server (step 658).

In one embodiment, a client, via the client device 202, inputs the information which is transmitted at step 658. As noted elsewhere herein, the information may include claim descriptive information, such as an insurance claim number, which may comprise of a alphanumeric number and/or the insurance company name; vehicle descriptive information, such as the year of the vehicle, the make and model of the vehicle, the mileage of the vehicle, the location of the vehicle, the date of loss, the VIN number; and/or damage related information, such as the estimated dollar amount, a full repair estimate, which may comprise a copy of the estimate from a auto-mechanic repair shop, digital photographs of the vehicle, and/or video of the vehicle. In another variant, the client may simply input the VIN number or ICN number and the SC server 100 retrieves certain portions of the information from item information servers 130.

Per step 660, the SC server 100 transmits the information to the salvage sources 120. In one embodiment, the SC server 100 determines which of the salvage sources 120 to transmit the information based on a salvage sources profile or previously entered information. For example, the profile in one embodiment filters the vehicle related information as to only transmit to salvage sources 120 e.g., based on geographic parameters, vehicle types, damage levels, etc. The geographic parameters may include certain zip codes, cities, or mileage radius from the salvage source 120. In another embodiment, the profile includes a subscription level. According to this embodiment, the subscription level may permit a salvage source to only be able to participate in the bidding for a vehicle, such as, so many times a week, month or year.

Next, at step 662 the SC server 100 receives multiple bids from the salvage sources 120. Per step 664, the client selects an offer from among the bids. It is appreciated that the selected offer may not necessarily be selected based on price. For example, the client may determine the best offer based on the distance of the vehicle to the salvage yard, previous relationship with the salvage source 120, etc. In one variant, the client may filter the bids based on zip code, city, or a mileage radius from the vehicle. In another embodiment, the client may determine the best offer based on historical performance information of the salvage source 120. The historical performance information may include ratings, cycle time, complaint data, and/or responsiveness. It is further noted that the SC server 100 may further enable a client to give a rating and/or provide feedback regarding a particular salvage source 120 in order to enable future clients to make a decision as to which sources 120 they would like to work with. In one variant, the client may filter the bids based on historical performance to determine the best offer. In yet another embodiment, the client may determine the best offer based on the services included by a salvage yard 120. For example, the services included may comprise free storage location, same day pickup, next day pick up, DMV and title transfer capability, pre-payment of accrued costs, and/or payment to insurer cycle time. The foregoing services may be further used by the client to filter bids.

Referring now to FIG. 6c, another embodiment of an exemplary method 670 of employing the SC server 100 of the present disclosure to obtain multiple bids on an item is described. The method 670 comprises at step 672 sending information about an item to the SC server 100 from a client device (such as one associated to an information provider 110). The information inputted by the client may include, e.g., the claim number, which may comprise of an alphanumeric number and/or the insurance company name, the year of the vehicle, the make and model of the vehicle, the mileage of the vehicle, the location of the vehicle, the date of loss, the VIN number, the estimated dollar amount, a full repair estimate, which may comprise a copy of the estimate from a auto-mechanic repair shop, digital photographs of the vehicle, and/or video of the vehicle.

In another embodiment, certain information about a vehicle or insurance claim may be obtained from one or more other information sources 130 based on submission of e.g., the VIN or ICN by the client to the SC server 100. In this embodiment, the SC server 100 then queries one or more item information servers 130, as described above, to retrieve descriptive information about the item, such as year, make model, mileage, estimate dollar amount etc. In addition, the SC server 100 may receive additional information such as a vehicle history report and/or estimated resale value.

Per step 674, the SC server 100 formats all of the information received from the information source 110 and/or outside sources 130 for transmission to participating salvage sources 120. In one embodiment, the participating salvage sources 120 are determined based on the salvage sources 120 profiles. In another embodiment, the participating salvage sources 120 are determined based on the salvage sources 120 subscription plan. The information provided thereto may be in the form of a formatted salvage report (FSR) or alternatively may comprise only a portion of the FSR with basic information; the salvage sources 120 may request additional information based on a level of interest in the portion of information viewed.

Per step 676, the salvage sources 120 each submit a bid to the SC server 120. The bids are in received in real time in one embodiment, and may include such information as the name of the salvage yard, phone number, contact person's name, alternative methods to contact (e.g., mobile phone or email), and/or location of the yard.

Per step 678 the submitted bids are stored in the storage device 106. In one embodiment, the client may run a monthly or annual report and used the submitted bids along with any other information to generate reports showing how much revenue or losses the client made on the items the client submitted for bidding. In addition, the client may run other reports, such as, showing how much more the client received for a particular item when compared to an average for other vehicles of that type, having that loss amount, within any geographic area, etc. The SC server 100 may further use this information to determine a monthly fee to charge to each salvage source 120 (e.g., based on number of bids entered and/or number of complete FSR received).

Per step 680, the client reviews the bids and selects an offer to purchase the item. The client may choose an offer based on e.g., the best offer price, past experience with a particular salvage yard, grading or rating of service provided, and other such parameters as best services, vehicle data, distance from the client.

At step 682, the SC server 100 sends a notification to the salvage source 120 that was selected (i.e., the “winner”). In one embodiment, the SC server 100 also sends notifications to the other salvage sources 120 that were not selected. These notifications may indicate if possible a reason their bid was not selected, as provided by the client. In addition, the notifications may include the amount and/or other details about the winning bid.

Per step 684, the transaction is completed. Completion of the transaction may, in one embodiment, include all necessary steps to effectuate the purchase of the item by the salvage yard 120, including e.g., completing and recording any necessary paperwork, and taking possession of the item. Additionally, the client receives payment for the item less any storage costs. In yet another embodiment, transaction information is stored in a profile for that particular salvage source 120.

Per step 686, upon completion of the transaction the client may optionally rate the transaction and/or the salvage source 120 which was selected. In one embodiment, the rating of the transaction is stored in the storage device 106 and may be used in conjunction with step 678 to produce various reports. In another embodiment, the rating of the transaction is stored in the storage device 106 and used in future bids to enable a subsequent client to select an offer (i.e., based on a rating or feedback from this previous completed transaction). In yet another embodiment, the transaction rating is additionally stored within the “winning” salvage sources 120 profile.

### Exemplary Interfaces—

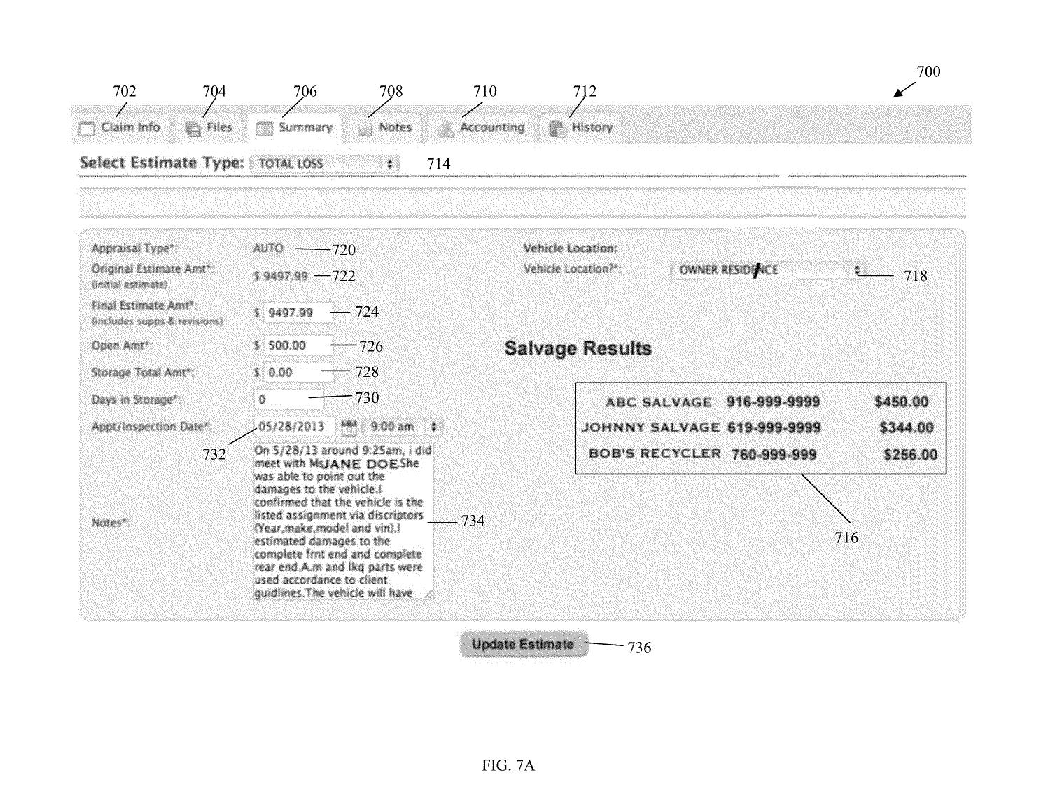

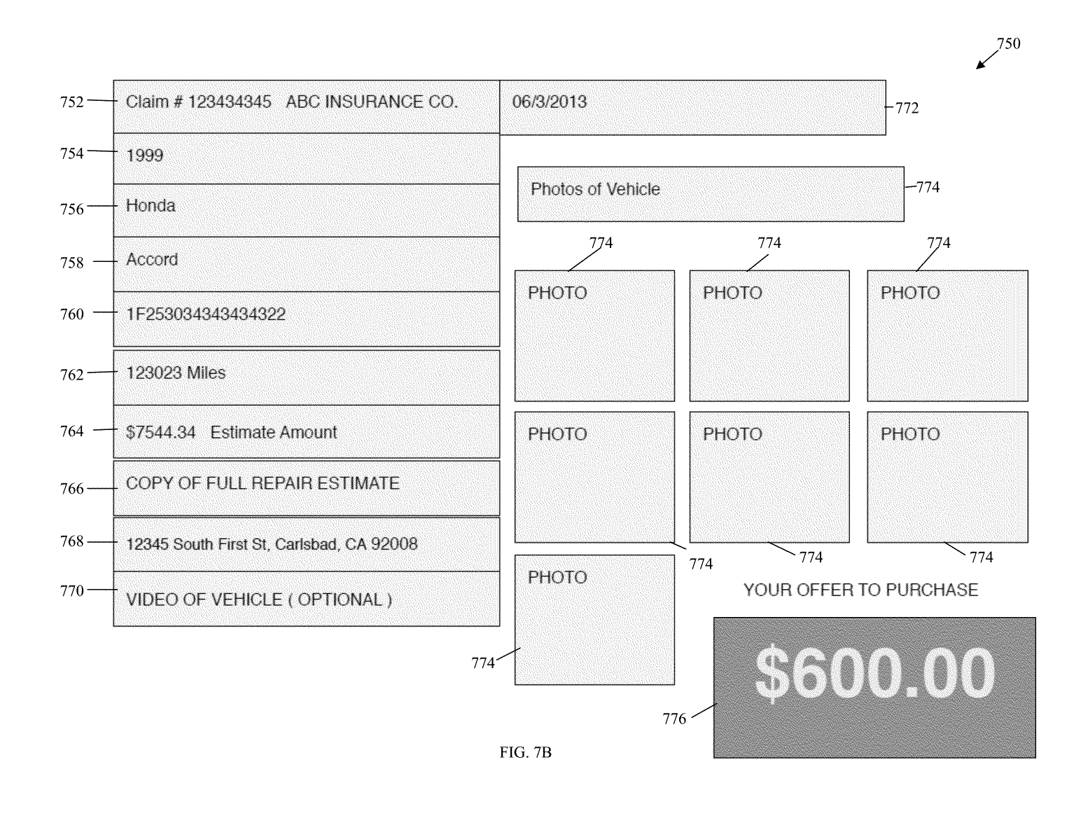

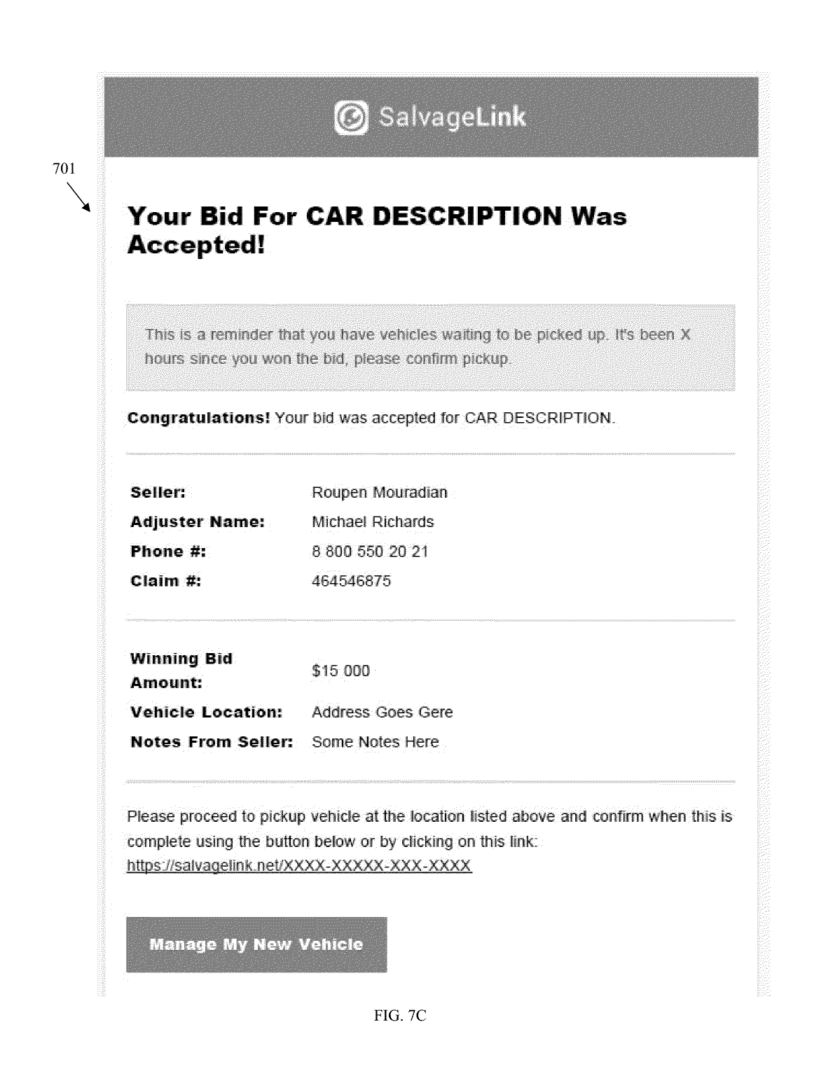

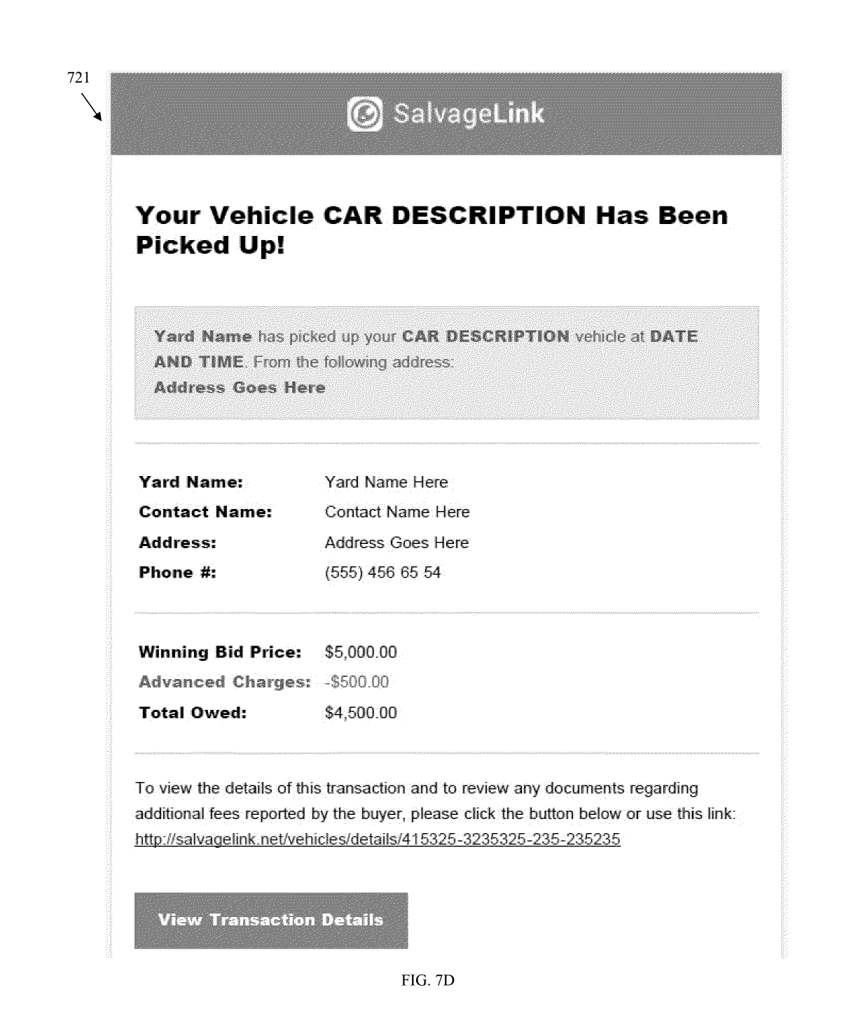

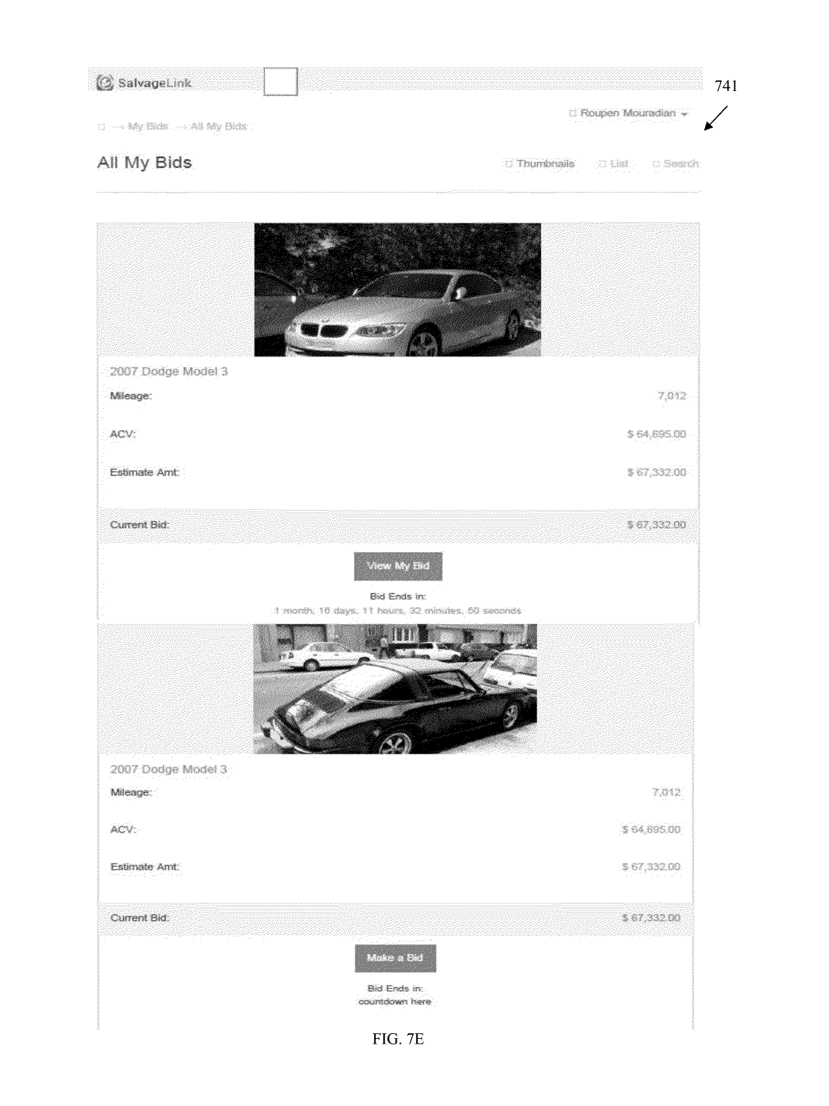

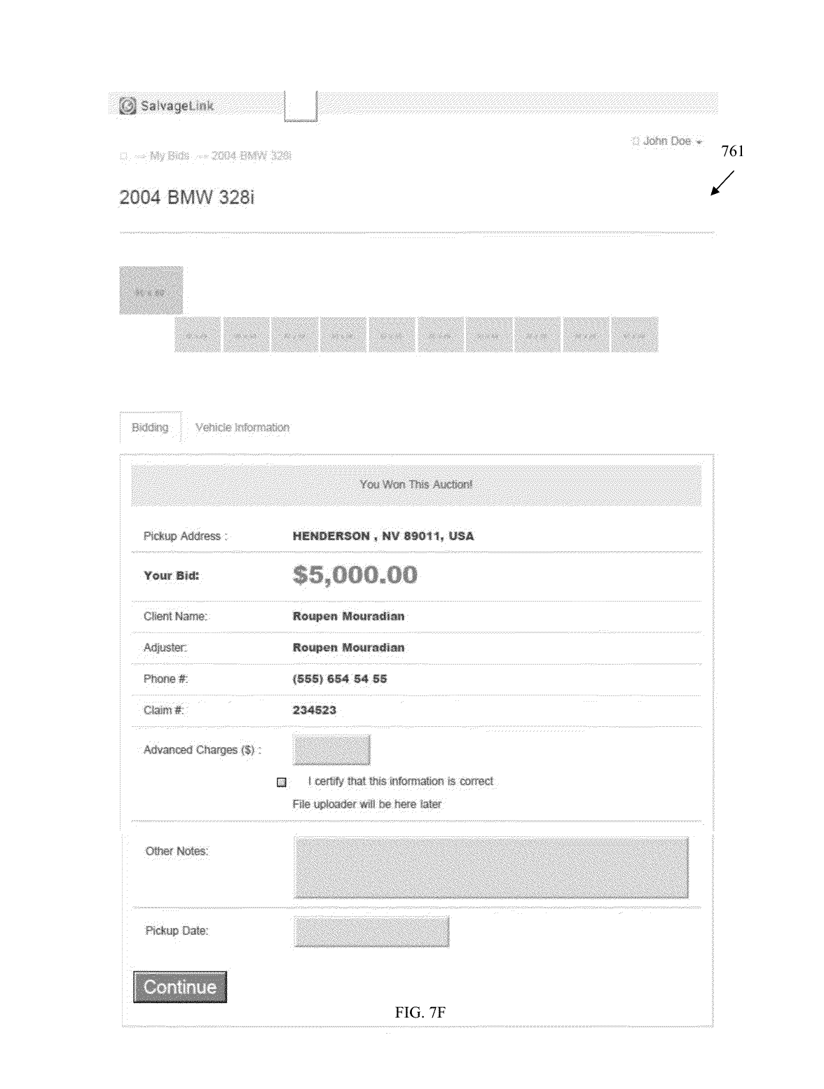

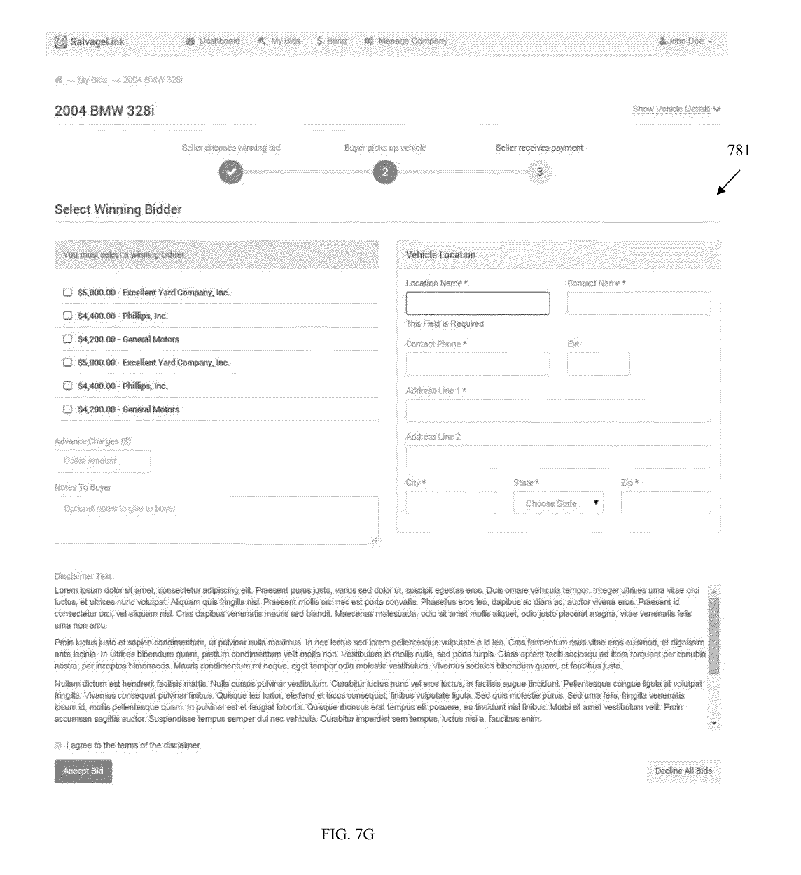

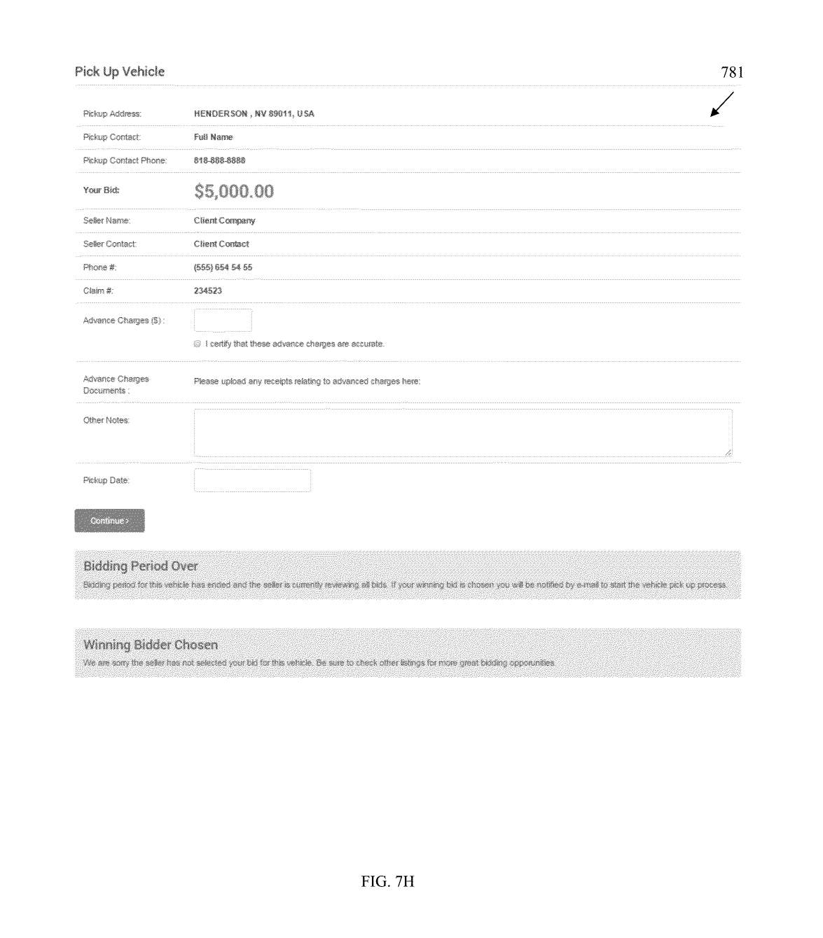

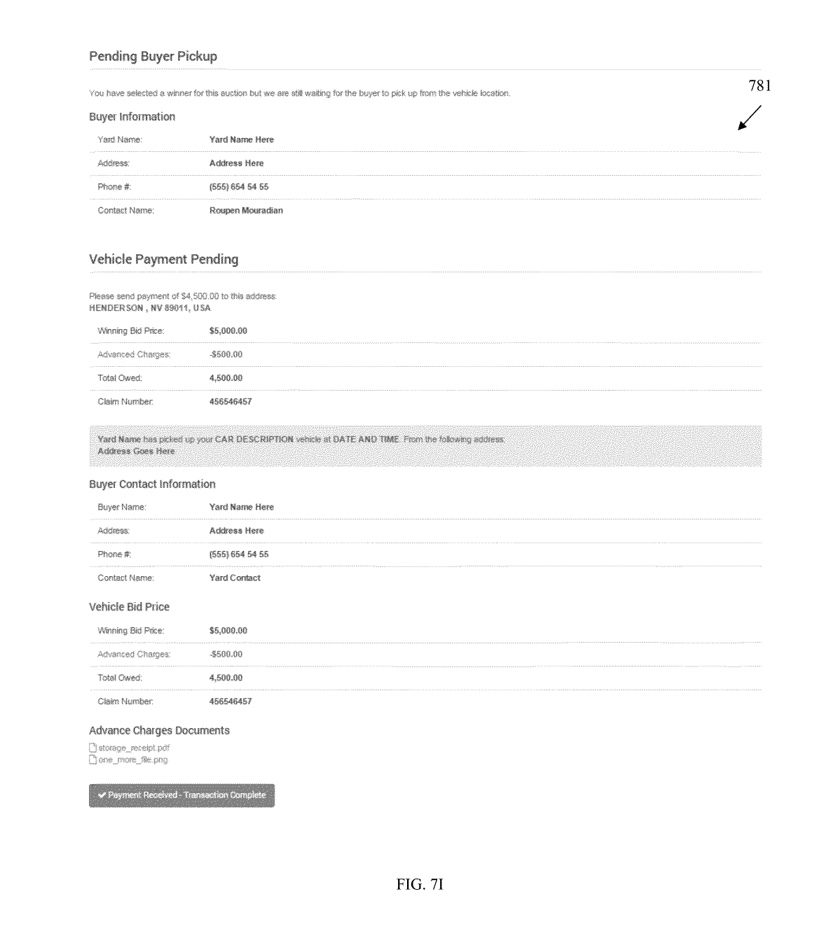

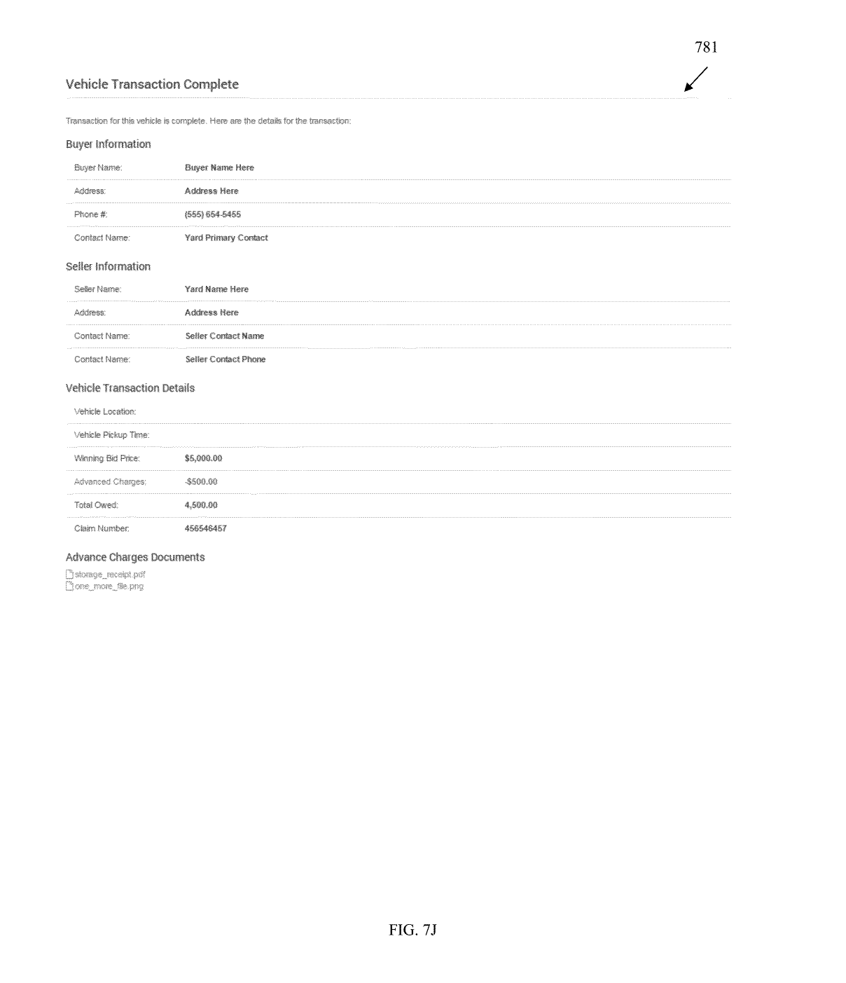

Referring now to FIGS. 7a-7j, exemplary interfaces 700, 701, 721, 741, 750, 761, and 781 for display to the client and to the salvage users on the client devices 202 are illustrated. The illustrated embodiments are in no way to be considered limiting, but rather are merely examples of interfaces that may be used consistent with the disclosure.

FIG. 7a illustrates an exemplary interface 700 for enabling a client to update and/or review bids on a particular item. As shown, the interface 700 generally comprises multiple tabs 702-712 which the client may select in order to view information. Under the tab 702 insurance claim information is provided for a particular item. The claim information includes information submitted by the client, via the client device 202. The client may comprise of a private individual, field appraiser, an adjuster, and/or a repair facility. The information submitted by the client may include: an insurance claim number (ICN); insurance company name; vehicle identification number (VIN); year, model, make, mileage and location of the vehicle; date of loss, estimate dollar amount; and copy of full repair estimate. Alternatively, some of this information may be obtained from outside or third party sources 130 (based on e.g., VIN).

The files tab 704 includes files submitted by the client. In one embodiment, the files may be document files (such as in pdf, word, etc. format), image files (such as in jpgs, img, etc. format), or video files (such as in wmv, avi, etc. format). The files may include such information as digital photographs of the vehicles, video of the vehicle, insurance claim documents and/or copies from repair shops estimating the cost to fully repair the vehicle.

Under the summary tab 706, the client may update an estimate and/or review previously submitted bids. The interface 700 further includes field where the user may select an estimate type 714, which is in the illustrated embodiment, selected from a drop down menu. In the given example, the client has selected an estimator type of “total loss”. Other options for an estimate type include e.g., partial loss, constructive total loss, total loss, etc. As illustrated, an appraisal type field 720 includes the type of item. In the illustrated example, the item type is a vehicle; additional types may include automobiles, motorcycles, boats, recreational vehicle (RV), heavy equipment, marine, specialty, etc.

The summary tab 706 further includes an original estimate amount field 722. The original estimate amount field 722 is populated based on the original insurance claim submitted as described supra.

In one embodiment, the summary tab 706 includes a final estimate amount field 724, which allows the client to enter an update to the original estimated amount (i.e., an adjustment). An update may be needed after a supplemental review of the item has been completed and it has been determined that the original estimated amount was incorrect. The final estimate amount may be higher or lower than the original estimated amount.

In another embodiment, the summary tab 706 includes an opening amount field 726, which allows the client to enter an amount at which the user would like bidding on the item to be opened. In another embodiment, the opening amount field 726 may allow the client to further enter a reserve amount (not shown). The reserve amount is a hidden minimum price-essentially, the lowest price that the client is willing to accept for the item. In this manner, if the bidding ends without any bids meeting the reserve then, the client is not required to sell the item. In one embodiment, the reserve is labeled with the text “reserved not met” next to the current bid price. Once the reserve price is met, the “reserve not met” label is removed.

In yet another embodiment, the summary tab 706 includes field which indicates a number of days in which the item has been in storage 730 and a field which represents the total amount (in a given currency, e.g., USD) that storage will cost 728. Accordingly, the client can input the number of days the vehicle may be in storage in the days in the storage field 730 and also input the cost of placing the vehicle in storage in the storage total amount field 728. In another alternative, the storage total amount field 728 is automatically populated when the client inputs the number of days the item will be in storage in the days in storage field 730 based on a known daily rate for storage.

In another embodiment, the summary tab 706 includes a field for an appointment/inspection date 732. In this embodiment, the client may enter appointments by inputting the date manually or selecting the calendar icon. In addition, the client may input the time of the appointment. In one variant, the client may also select to be provided with a reminder based on the entered date/time. In another variant, the client instead of inputting a future appointment may input a past appointment/inspection. As is also illustrated, the summary tab further includes a notes field 734. The notes field 734 allows a client to include notes about future or past appointments/inspections. The client may input such information as the person they are to meet or have met, information about that person, and details about the appointment and inspection of the item.

In yet another embodiment, the summary tab 706 includes a vehicle location field 718. The vehicle location field 718 indicates where the item is currently located.

Further, in the summary tab 706, a salvage results field 716 is given. The salvage results field 716 includes such information as, the name and phone number of the salvage source and the salvage source's current bid for the particular item. In one variant, the client may mouse over the salvage source to provide additional information, such as the person of contact, other forms of contacting (e.g., email address, cell phone number, etc.) and the salvage source's address.

In another embodiment, the summary tab 706 includes an update estimate button 736. The update estimate button 736 is used when the client has made an update to one or more of the fields described above. When the client clicks on the update estimate button 736 the updates to the fields are saved.

In yet another embodiment, the interface 700 includes a notes tab 708. The notes tab 708 may include any additional notes taken during appointments/inspections as entered in the summary tab 706. In one variant, the notes tab 708 includes other such information as notes taken during the insurance claim, subsequent appraisals, personal notes about the vehicle, and/or auto-mechanic shops; whereas the noted tab 708 represents a summary for these notes.

In yet another embodiment, the interface 700 includes an accounting tab 710. The accounting tab 710 allows a client to enter billing information for the purchase of an item, or for prospective purchases of the item. The accounting tab 710 may comprise a billing information entry segment having a plurality of fields. The fields enable the client to enter, a billing name, address, card number, etc. Although not illustrated, the accounting tab 710 may further display the descriptive information as illustrated in previous interface embodiments. Additionally, the accounting tab 710 in another embodiment provides instructions for the purchase of reports described elsewhere. A salvage source 120 may purchase a report by identifying an item (such as by VIN or ICN) to which the report will relate. In another embodiment, the accounting tab 710 may allow the client to deactivate their account or the account of a salvage source by clicking on a deactivate account icon. In this embodiment, the client has authorization to deactivate the account of a salvage source. In one variant, the salvage source may deactivate their account by clicking on the deactivate account icon. In yet another embodiment, the account tab 710 is its own interface.

In yet another embodiment, the interface 700 includes a history tab 712. The history tab 712 in one embodiment displays a summary of the information obtained by the SC server 100 when the item information servers 130 are queried. In another variant, the history tab 712 provides additional information to a client or salvage source 120 regarding information provided in one of the reports described above. The description indicating descriptive information about the item for sale is displayed. When the client or salvage source scrolls over the sample report section, a general description of what is provided in the reports is displayed to the client or salvage source. In another embodiment, the history tab 712 provides vehicle history information such as, mileage of the vehicle, past insurance claims, past vehicle repairs etc.

In another exemplary interface, an error message interface may be displayed. The error message in one example may state “404—Not Found”. In another example, the error message may also include a message such as: “Sorry! You have reached a part of the site that is not currently active. During the pre-registration and beta process for this system, parts of the site may become available. These sections should be fixed shortly”. In addition, the error message interface includes a link that allows the client or the salvage sources to click on, redirecting them back to a home page interface. In on variant, an under construction interface may be displayed to the client and/or the salvage source. The under construction interface may include a message such as “Please excuse us while we fully test and integrate the site during this pre-registration phase. We will have lots of great features available for you shortly!”

In one variant, the interface allows the client or the salvage source 120 to input or update their credit card information. The interface includes multiple input fields for a user to input information. The input fields may include one or more of the following: (i) credit card number, (ii) card verification value (CVV), (iii) expiration date, (iv) credit card type, and/or (v) billing address. In addition, the interface includes a button for the client or the salvage source to click on to update and/or submit their credit card information. In another variant, the client and/or the salvage source may be presented with an interface to edit their user information. The interface may include multiple input fields such as, first name, last name, email, primary phone, extension, etc. In addition, the interface may include a save changes button for the client and/or the salvage source to click on and save their inputted information.

In another example, an interface displaying invoices may be presented to the client. The invoices may be presented in a list. The list may include one or more of the following column headings to accompany information from each invoice: (i) invoice number, (ii) date issued, (iii) invoice total, and/or (iv) status. Under the invoice column is an invoice number, which in one embodiment may be a hyperlink. The hyperlink allows the client to click on the invoice number and be redirected to another interface such as the summary tab 706 or another interface providing information about that particular invoice. Under the date issued column the date the invoice was issued is listed. Under the invoice total column the dollar amount of the invoice is listed. Under the status column a status identifier of the invoice is listed. The status identifier may include such identifiers as paid in full, partial payment, open, overdue etc.

Another example of an interface is an alert interface. In this example, the client or the salvage source may be presented with an alert message. The alert message may include a default alert, an information alert, an error alert, a warning alert, a success alert, etc. Each of the alerts may be accommodated with a noise when displayed to the client or the salvage source. In addition, the alert may also include a short message, for example, the information alert may include “Thanks for Pre-Registering. We will notify you when our beta period begins”.

In another embodiment, the client may be presented with an edit client interface. In this embodiment, the interface may include an input field for the client to update the client name. In addition, the interface may include such other input fields as contact information (e.g., address, phone number, email, etc.). Furthermore, the interface includes a save changes button or icon for the client to click on and submit the changes.

In one variant, the interface may further include a client list interface. The client list interface may include a table with multiple columns. The columns may have headings such as a name, a primary contact and users. Under the name heading is the client or the salvage source's name. Under the primary contact heading a contact name of the primary contact may be listed. Under the users column lists the name of the users. Under each of these columns the name, the primary contact and/or the user(s) may include a hyperlink. The hyperlink may be part of the name, the primary contact and/or the user(s) and the hyperlink directs the client to another interface such as the summary tab 706 or another interface providing information about the client name, the contact name and/or the users. In addition, the client list interface may include a page navigation bar, which allows the client to view other pages within the client list interface.

In yet another variant, the interface further includes a view item interface. The item vehicle interface includes photographs of the items currently available to bid on. The client or the salvage source can click on one of the pictures and be directed to another interface such as the summary tab 706 or another interface providing information about the item.

Another example of an interface that may be presented to the client and/or the salvage sources is a preference interface. The preference interface includes notification preferences, bidding preferences (i.e., address), bidding preferences (i.e., States), etc. Under the notification preferences the client and/or the salvage sources can select such preferences as to be emailed on new bidding opportunities, emailed when a bid has been accepted, emailed when they have been outbid, etc. In addition, a save changes button is located on the preference interface for the client or the salvage sources to click on and save their preferences. Under the bidding preferences, the salvage sources can select such preferences as to be emailed on new bidding opportunities in a certain state, specific locations within a state, or a certain distance from an address, etc. The preference interface may further include a billing contact section which allows the salvage source or the client to specify the individual responsible for item billing related issues and a billing address section which allows the client and/or the salvage source to update their billing address.

FIG. 7b illustrates an exemplary interface 750 for enabling the salvage source 120 to enter an offer to purchase an item. The interface 750 generally includes a summary of information regarding the item. The summary information may include for example and without limitation any one or more of the following: a claim number 752, which may include an alphanumeric number and/or insurance company identifier, a year of the vehicle 754 (e.g., 1999), a make of the vehicle 756 (e.g., Honda), a model of the vehicle 758 (e.g., Accord), a VIN number 760, which may include an alphanumeric number, a mileage of the vehicle 762, an estimate amount 764, a copy of full repair estimate 766, an address field 768, which may include the address of the item's owner or where the item is currently being stored/held, a video of the item 770, and a plurality of photos 774 of the item. In addition, the interface 750 may include a date field 772, which provides the date and/or time for submitting a bid to an offer to purchase. In the purchase field 776, the salvage source 120 wishing to make a bid on the item may enter a dollar amount therefor.

FIG. 7c illustrates another exemplary interface 701 for display to the salvage sources on the client devices 202. As shown, the interface 701 generally comprises an indication that the salvage source bid for a particular item was accepted and selected as the winning bid. The interface 701 includes a reminder which, for example, states “This is a reminder that you have vehicles waiting to be picked up. It's been X hours since you won the bid please confirm pickup”. In addition, the interface may include a congratulations message, the seller's name, and adjuster's name, phone number of the seller and/or the adjuster and the claim number of the particular item. Also, the interface 701 may include the winning bid amount, the location of the item and any notes from the client. In addition, the interface 701 may include a message, which states for example “Please proceed to pickup vehicle at the location listed above and confirm when this is complete using the button below or by clicking on this link: https://salvagelink.net/xxxx-xxx-xxxx”. Furthermore, the interface 701 may include a button for the salvage source to click on to manage the item recently purchased.

In another embodiment, another interface indicating that the bidding for a particular item is complete may be provided to the salvage source. The interface may include a message, which states for example “Bidding has completed on this vehicle. There are [BID COUNT NUMBER] bids currently placed. Please review the bids and choose a winning bid. You may click this link or the button below to automatically log in directly to the bid review process: http://www.salvagelink.net/vehcile/review/xxxxxxxx-xxxxxxx-xxxxx”.

FIG. 7d illustrates another exemplary interface 721 for display to the salvage sources on the client devices 202 is illustrated. As shown, the interface 721 generally comprises a message indicating that the item including a description of the item has been picked up. In addition, the interface 721 includes another message which includes the name of the salvage source that has picked up the item on a specific date, time and location. In addition, the interface 721 includes multiple fields, the fields include the salvage source's name, contact person name, address, and phone number. Also, the interface 721 may include the winning bid price, any advanced charges and the total amount owed. Furthermore, the interface 721 may include a message, which states for example “[t]o view the details of this transaction and to review any documents regarding additional fees reported by the buyer, please click the button below or use this link: http://salvagelink.net/vehcile/details/xxxxxx-xxxxxxx-xxx-xxxxxx”.

In another variant, the client and/or the salvage source may be presented with an interface indicating that a new account has been created. In addition, the interface may include a message, which states for example, “Before you can log in to SalvageLink, you will need to create a password for your account. Please click the button below or below this link: . . . ”. Once the client and/or the salvage source have completed registration they may be presented with an interface indicating that their registration is now complete. To sign into an account, the client and/or the salvage source may be presented with a sign in interface. The sign in interface includes multiple input fields for the client and/or the salvage source to input their username and password. The client and/or the salvage source may also be able to check “a remember me” box for automatic log in for future log in sessions. In addition, the sign in interface may include a sign in button, a forgot your password link and a register here link for the client and/or the salvage source to click on.

The client and/or the salvage source may be presented with a forgot your password interface. This interface may provide the client and/or the salvage source a message which states for example “A password reset request has been initiated from this e-mail address. If you did not mean to send this request you can ignore this e-mail. To reset your password please click the button below or follow this link: . . . ”. In one variant, the client and/or the salvage source may be presented with a password reset e-mail interface, which includes a message. The message may state “Please check your e-mail for the password reset link. Once you click this link it will give you the option to set a new password for your account”. In addition, the client and/or the salvage source may be presented with an email reset password interface. The email reset password interface includes multiple input fields for the client and/or the salvage source to input their new password in one of the input fields and re-type their password in another input field, to confirm they have correctly typed their password. In the case where the client and/or the salvage source has incorrectly typed their password a message will be displayed indicating that the passwords do not match. The email reset password interface also includes a submit button for the client and/or the salvage source to click on when resetting their password. When a password reset has been completed, the client and/or the salvage source may be presented with an interface that the password reset has been completed. In addition, the password reset complete interface may include a message which states for example “Your password has been successfully reset. You may now log in to SalvageLink with your new password”. In addition, the password reset complete interface may include a log in now button, which the client and/or the salvage source may click on.

In another example, the salvage source may be presented with an interface for editing their profile. The interface may include multiple input fields for the salvage source to input one or more of the following: company name, business phone number, street address, city, state and zip code. In addition, the interface may include a button for the salvage source to click on and save the changes inputted.

FIG. 7e illustrates another exemplary interface 741 for display to the salvage sources on the client devices 202 is illustrated. As shown, the interface 741 generally comprises a list of all of the salvage sources current bids. The interface includes an image of the item, the model type, mileage, actual cost value (ACV), estimate amount, and the current bid dollar amount. In addition, the interface 741 may include a countdown timer which may include the number of months, days, hours, minutes and seconds until the bidding ends. In one variant, the interface 741, includes a button that the salvage source may click on to view their bid for that particular item. The button in one embodiment redirects the salvage source to another interface which provides additional information about the particular item, for example to the tab 706 interface.

Another example of an interface that may be presented to the client and/or the salvage source is a manage company user interface. The manage company user interface may include a table with multiple columns and rows. The headings on the columns may include name, email, role and status. Under the name column includes the user's name of the salvage source. Under the email column is the preferred email address for that particular user of the salvage source. Under the role column lists the role for that particular user of the salvage source. One of the particular roles may be administrator. Under the status column lists the status of that particular user. The status indication in one embodiment may include member or insurance company. In addition, the client list interface may include a page navigation bar, which allows the client to view other pages within the client list interface.

In another embodiment, the salvage source may be presented with multiple interfaces when registering their company. The first interface may include a choose your plan interface. The choose your plan interface may include multiple options for the salvage source to select. For example, the options may include a starter option, a regional option and a national option. Under the starter option, the plan may include a fee of $100 per month, listings within a one hundred (100) mile radius, $25 per winning bid under $5000, $75 per winning bid greater or equal to $500. Under the regional option, the plan may include a fee of $250 per month, listings from ten (10) states, $25 per winning bid under $5000, $75 per winning bid greater or equal to $500. Under the national option, the plan may include a fee of $500 per month, access to any listing in the country, $25 per winning bid under $5000, $75 per winning bid greater or equal to $500. Under each of these options may be a sign up button for the salvage to click on and continue to a second interface. Although illustrated with only the above described options, it is appreciated that any options may be provided consistent with the present disclosure.

The second interface may include a user information interface. The user information interface may include multiple input fields. The input fields may include such fields as, a first name field, a last name field, an email address field, a primary phone number field, an extension number field, a password field, a confirm password field, etc. In addition the user information interface may include a your company information section, which includes multiple input fields such as, a name field, a business phone number field, and an extension number field. The multiple input fields may include an asterisk by them which indicate that a particular field is required. In addition, the interface includes a back button and a continue button for the salvage source to click on. The back button allows the salvage source to go back to the first interface, while the continue button allows the salvage source to continue to a third interface.

The third interface may include a billing setup interface. The billing setup interface includes multiple input fields. The input fields may include such fields as, a credit card number field, a CVV field, an expiration date field, an address line 1 field, an address line 2 field, an address city field, an address state field, an address zip code field, etc. The salvage source for each of these fields may input the appropriate information. The multiple input fields may include an asterisk by them which indicate that particular field is required. In addition, the interface includes a back button and a continue button for the salvage source to click on. The back button allows the salvage source to go back to the second interface, while the continue button allows the salvage source to continue to a fourth interface.

The fourth interface may include a documents setup interface. The documents setup interface includes an upload your document field. The upload your document field includes a section for the salvage sources to upload the necessary licenses required to do business in the states the salvage source intends to be doing business in. The necessary licenses may include a business license, a salvage/dismantlers license and/or a commercial liability/garage keepers insurance. In addition, the interface includes a back button and a continue button for the salvage source to click on. The back button allows the salvage source to go back to the third interface, while the continue button allows the salvage source to continue to a fifth interface.

The fifth interface may include a signature interface. The signature interface includes a terms of service section, which outlines the rules which the salvage sources must agree to abide by in order to use the services described herein. In addition, the terms of service may also include a disclaimer. The signature interface may also include a signature input field, where the salvage source may enter an electronic signature. In addition, the interface includes a back button and an agree button for the salvage source to click on. The back button allows the salvage source to go back to the fourth interface, while the agree button forwards the salvage source to a registration complete interface. The registration complete interface may include a message, which states for example “Thank you, your account has been submitted to our staff for review. During the pre-registration process functionality is limited but you will be notified via e-mail as soon as new features become available for use”. In addition, the interface includes an enter webpage button for the salvage source to click on and enter the website.

In yet another embodiment, the client may be presented with an add item interface. The add item interface may include multiple sections. The multiple sections may include item information and item location. Under the item information section includes multiple input fields. The multiple input fields may include an item year field, an item make field, a model item field, a type of item field, a claim number field, an actual cash value field, an estimate field, a point of contact field, a mileage field and a vehicle identification field. In one variant, the item information section includes an assigned user designation. The assigned user designation includes the option of selecting a new user or an existing user. The new user option requires the client to enter information about the new user. The information entered by the client about the new user may include the first name, last name, primary phone number, extension and email. Under the item location section includes multiple input fields. The multiple input fields may include, a location name field, a contact name field, a contact phone number field, an extension number field, an address line 1 field, an address line 2 field, a city field, a state field, and a zip code field. In addition, the add item interface includes a continue button which directs the client to an item image interface. The item image interface allows the client to upload multiple item images. In addition, the interface includes a back button and a create listing button for the client to click on. The back button allows the client to go back to the add item interface, while the create listing button allows the client to upload the listing.

Another example of an interface that may be presented to the salvage source is an all my bids interface. The all my bids interface includes a table with multiple columns and rows. The columns have headings, which may include such titles as name, mileage, actual cash value, estimate value, bidding ends in and my bid. Under the name heading lists the name of the item, which may include the year of the item, make of the item, and model of the item. Under the mileage heading is the number of miles on the item. Under the actual cash value heading lists the actual cash value of the item, while the estimate amount heading lists the estimated value of the item. Under the bidding ends header lists the number of days, hours, and seconds before bidding ends for the particular item. Under the my bid heading lists at least one of the following, the dollar amount bid, an indication that you won this item, an indication that you lost this item, or an indication that you did not bid yet on this item. In addition, the all my bids interface may include a page navigation bar, which allows the salvage source to view all of its current and/or past bids.

FIG. 7f illustrates another exemplary interface 761 for display to the salvage sources on the client devices 202 is illustrated. As shown, the interface 761 generally comprises multiple images of the item, a bidding information tab and an item information tab. Under the bidding information tab the salvage source may be presented with a message that states that the salvage source won the bidding for the particular item. In addition, the bidding tab may include such information as a pickup address for the item, a bid amount for the item, a client name, an adjuster name or an adjuster company name, a phone number, and a claim number. In one variant, the bidding tab includes multiple input fields. The input field may include an advanced charges field, where the salvage source may advance charges for the item. In addition, a certification check box is also provided, which when checked certifies that the information (i.e., dollar amount) inputted in the advance charges field is correct. The input field may also include an other notes field, which allows the salvage source to include notes and a pickup date field, which the salvage source may input a date they intend on picking up the item. The interface may also include a continue button for the salvage source to click on and advance to another interface such as a billing interface. Under the vehicle information tab includes information about the item as described throughout the disclosure.

Another example of an interface is a send payment interface. The send payment interface includes a message which states for example “Please send payment of $4,500.00 to this address: XXXX Henderson, NY XXXXX, USA”. In addition, the send payment interface may include the following information, a winning bid price, advanced charges, total owed, and a claim number. Payment may also be made electronically.

In another variant, an interface displayed to the client is a notification interface. The notification interface may include a message which states that the salvage yard has pick up the item on a specific date and at a specific time, from a specific address. In addition, the notification interface may include contact information, vehicle bid price and uploaded documents. The contact information may include the salvage yards name, address, phone number and contact name. The vehicle bid price may include the winning bid price, the advanced charges, the total owed and the claim number. The uploaded documents may include a storage receipt.

FIGS. 7g-7j illustrates another exemplary interface 781 for display to the client on the client devices 202 is illustrated. As shown in FIG. 7g, the interface 781 generally comprises a select winning bidder section. The select winning bidder section includes a list of bids for the particular item. The bids include the dollar amount and the name of the salvage source. In addition, multiple input fields are displayed for the item location. The multiple input fields includes at least one of the following a location name field, a contact name field, a contact phone number, an extension number, an address line 1 field, an address line 2 field, a city field, a state field and a zip code field. The interface 781 may also include a disclaimer text, an accept bid button and a decline all bids buttons. To accept a bid as the winning bid the client may also check an “I agree to the terms of the disclaimer” check box.

As shown in FIG. 7h a continuation of the interface 781, the interface 781 further comprises a pick up vehicle section. The pickup vehicle section includes information such as a pickup address, a pickup contact name, a pickup contact phone number, the winning bid amount, a seller name, a seller contact, a seller contact phone number, and a claim number. In one variant, the interface 781 includes multiple input fields. The input field may include an advanced charges field, where the salvage source may advance charges for the item. In addition, a certification check box is also provided, which when checked certifies that the information (i.e., dollar amount) inputted in the advance charges field is correct. The input field may also include an other notes field, which allows the salvage source to include notes and a pickup date field, which the salvage source may input a date they intend on picking up the item. The interface may also include a continue button for the salvage source to click on and advance to another interface such as a billing interface. In another variant the interface 781 may also include a first message indicating that the bidding period is over and a second message indicating a winning bidder has been chosen.

FIG. 7i a continuation of the interface 781, the interface 781 further comprises a pending buyer pickup section, a vehicle payment pending section and a buyer contact information section. Under the pending buyer pickup section a message indicating that the client has selected a winner for the item may be displayed. In addition, the message may also include that the item has not been picked up. The pending buyer section may also include buyer information such as the salvage source name, the salvage source address the salvage source phone number and a contact name. Under the vehicle payment pending section lists the winning bid price, any advanced charges, the totaled owed and the claim number. In addition, a message indicating where payment should be sent may also be displayed. Under the buyer contact information section lists the buyer's name (i.e., the salvage source), a buyer's address, a buyer's phone number and a contact name. In addition, the buyer contact information section may include the item bid price, any advanced charges, the total amount owed, the claim number and any advanced charges documents. In addition, when a payment is received a notification may be displayed on the interface 781 which may state “payment received—transaction complete”.

FIG. 7j a continuation of the interface 781, the interface 781 further comprises a vehicle transaction complete section. The vehicle transaction complete section may include the buyer information, the seller information and the vehicle transaction details as described above.

### Verbal Bidding—

It is further appreciated that the aforementioned systems and methods may be implemented in verbal form. In other words, the salvage source 120 may connect to a telephone access system. The telephone access system may comprise an automated system accessed by the salvage source 120 dialing a telephone extension (such as a toll-free, 800, or 866 number). The salvage source 120 is then connected with a first menu where the salvage source 120 may speak, or dial a VIN (or shortened VIN) or ICN. The VIN or ICN is confirmed if necessary, such as by a mechanism for verbally repeating the VIN or ICN back to the salvage source 120 so that the salvage source 120 may confirm (such as by pressing a key to indicate correctness). Where the repeated VIN or ICN is not correct, the salvage source 120 may be given an option to indicate it is incorrect and re-enter it (either by speaking or dialing). The confirmation step reduces erroneous reporting.

Next, the entered VIN or ICN is then used to obtain information regarding the item. In one embodiment, the methods disclosed above, e.g., utilizing the SC server 100, are implemented at this step. Other methods for obtaining information regarding an item may also be utilized as well.

The salvage source 120, selects from among one or more options for the presentation of the information. For example, the user may select to have the information presented verbally (such as via a computer automated speech synthesis system), or presented in email, text/SMS message or other message form. This selection may also be pre-stored; e.g., the salvage source 120 may configure his/her account such that it always defaults to text delivery unless told otherwise. The information is then presented to the salvage source 120 via the selected mode.

The salvage source 120 may also submit a bid on the particular item either by speaking or dialing the dollar amount. The dollar amount is confirmed, such as by a mechanism for verbally repeating the dollar amount back to the salvage source 120 so that the salvage source 120 may confirm (such as by pressing a key to indicate correctness).

### Client Interface/Account Generation and Management—

The features and options discussed above may, in one embodiment, only be made accessible to the clients and the salvage sources 120 that have registered and generated an account with the SC server 100. Registration and account generation may be coordinated through one or more Internet-based interfaces. Thus, the client or the salvage sources 120 may be able to set-up an account with the SC server 100 via an Internet connection and a device capable of accessing the Internet (such as a PC, laptop computer, PDA, or other client device).

In order to establish an account (register or set-up), the client and/or the salvage source 120 will navigate any standard internet browser in order to access a website tied to the SC server 100. The website will have at least one tool for demonstrating the capabilities of the SC system as well as one tool for enabling clients to “sign up” for SC system services.

It is appreciated that a quick description of product and advertising slogans may be displayed on one or more pages of the website. One or more pages of the website may advertise a dedication to quality, and the general purpose of the SC system. The SC system partners (such as item information server 130 owners) may also be displayed to clients and potential clients. For example, the website may indicate a partnership with such companies and services as, inter alia, Auto Check, CarFax (for providing vehicle history reports), and Manheim (for providing wholesale pricing information).

Information regarding membership fees, service fees, and subscription levels may also be presented to clients via the web interface. A linked email address and/or questions/comments page may also be presented.

The website will present the client and/or the salvage source 120 with a policy and licensing agreement for use of the protected methods and apparatus of the SC system with an option for the client and/or the salvage source to accept the terms thereof.

Actual registration (set-up) of an account comprises providing the SC server 100 with a name, company name and address a phone number associated with the client's client device (for accessing and utilizing the SC system) via the web-based interface. In one embodiment, once the client and/or the salvage source 120 has entered the above information, the client and/or the salvage source 120 may test functioning of the system by indicating a desire to receive a test message from the SC server 100. After the system has been optionally tested, the client and/or the salvage source provide payment information (including credit card account number, bank information, check card information, check routing number and account, and/or debit card information). The client and/or the salvage source will be given options to select from subscription plans and/or billing options (such as monthly, weekly, per request, etc.).

Once the payment and other information is received by the SC server 100, the client and/or the salvage source 120 will be associated to an account number and added to a client database associated with the SC server 100.

The client and/or the salvage source 120 will then establish an account password and login ID so as to be able to review and edit his account options at the web-based interface (e.g., change payment information, change status of the account, change a subscription level, change a telephone number, and/or change the current password or login ID associated with the client's account, etc.), pay bills, view upcoming bidding opportunities, receive email messages, etc. It is appreciated that in the event the client and/or the salvage source is unable to enter a proper login ID and/or pass word, temporary and/or then-existing passwords and/or ID will be sent to the client device associated with the account via SMS message.

### Preferences and Searching—

In another embodiment, the salvage source 120 or client may be provided with options for searching a database of items (or other bid items) at the web interface. The salvage source 120 is given access to multiple bidding opportunities listed by location and/or date. The salvage source 120 can then search the bidding opportunities of interest for items having particular features or options that the salvage source 120 is interested in. For example, a particular salvage source 120 may be interested in purchasing a Honda. The salvage source 120 enters features of the Honda such as year, model, color, mileage, etc. into a search engine. The search engine then returns a list of all of the vehicles up for bidding which match the salvage source's 120 criteria. The search engine is, in one embodiment, adapted to search the bidding items according to any of the aforementioned criteria as well as others not specifically listed yet germane to the bidding items themselves.

It is also appreciated that a salvage source 120 may create a personalized list of items the salvage source 120 would like to bid on (e.g., specific vehicle parts). In other words, the salvage source 120 may select one or more items (or other items for bidding) to receive notifications, alerts, or other messages about; the items may be selected from, e.g. the results of the aforementioned search and/or may be manually entered. The salvage source 120 may be given an option to have the personalized list forwarded via email, SMS text message, voice message or otherwise to the salvage source's client device prior to the date and time the bidding is to take place with respect to a given vehicle having an item of interest and/or a particular vehicle of interest (such as any Honda). As noted previously, the salvage source's client device may comprise any mobile electronic device capable of receiving SMS or other data/text messages, email messages or voice messages, such as e.g., a 3G smartphone with broadband capability.

Information used in creating the personalized list, as well as the list itself, are held confidentially and securely, such as by utilizing a Secure Sockets Layer (SSL) or Transport Security Layer (TSL) tunnel to transmit data.

### Tracking Services—

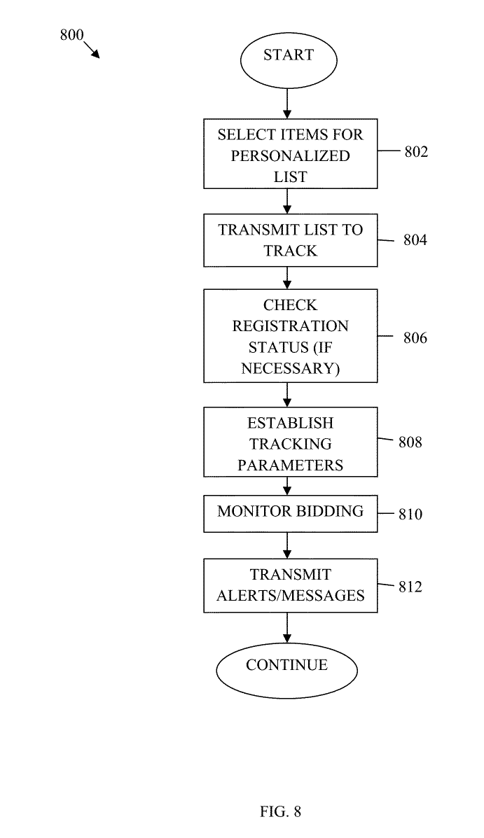

In yet another embodiment, the SC server 100 may be utilized to track the sale of particular items (e.g., specific vehicles and/or available parts). In one variant, the SC server 100 tracks the status of each of the items being bid on according to the method 800 illustrated in FIG. 8.

As shown, at step 802, items are selected by the client or salvage source 120 for a personalized list. The items are selected for example as described above, e.g., specific brands, specific models, specific part numbers, etc.

The list is then transmitted or linked to the SC server 100 (step 804). The link between the personalized list and tracking system may be established via any number of methods. For example, information regarding each client or salvage source's personalized list may be securely or non-securely transmitted from a first web server to a SC server 100 every pre-determined interval of time (e.g., every 2 minutes, etc.). In another embodiment, personalized lists, as soon as created, are forwarded to a SC server 100. Other procedures may be used as well.

Per step 806, the lists are optionally examined to determine whether the client or salvage source 120 associated with the list has also enrolled or registered for the tracking system. If the client or salvage source 120 has not registered, they will be given an opportunity to do so.

Next, at step 808, the client or salvage source 120 establishes the aspects of tracking. For example, the client or salvage source 120 may establish that the server should send an alert to the client or salvage source's device (either via SMS text, voice, data, or email message) when a tracked item is a pre-determined number of minutes away from bidding to begin and/or end, when the bidding on the item has begun, when the bidding on the item has ended, when the bidding on the item has reached a certain dollar value, etc.

Per step 810, the SC server 100 monitors the bidding. The SC server 100 may be updated via methods, which implement current technologies for managing status of the items being bid on.

The SC server 100 functionality uses the updated bidding information to, at step 812 determine which clients or salvage sources 120 to alert (such as by sending text or other messages to the user) regarding items which the client or the salvage source 120 has elected to track. In a further variant, a client or salvage source 120 may communicate with the SC server 100 so as to track an item during, or just prior to the beginning of bidding. In this embodiment, a client or salvage source 120 may, via a client device send a message to the SC server 100 indicating a VIN number or ICN number to begin tracking. In the instance the client or salvage source 120 has a personalized list, the additional item may be added thereto. It is also appreciated that a client or salvage source 120 may be granted access to the tracking system via a web interface; the interface providing the client or salvage source 120 a means for entering a VIN or ICN number for the item to be tracked.

### Recommendations—

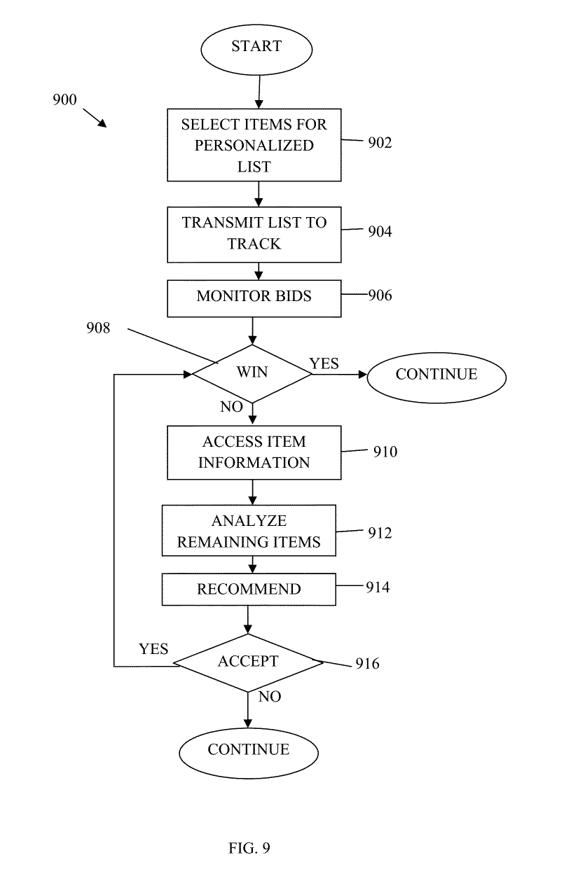

The SC server 100 may further be utilized to recommend items to a salvage source 120 based on previously bid on items as illustrated in the method 900 of FIG. 9. As illustrated, per steps 902 and 904, the salvage source 120 creates a personalized list of items, which is transmitted to the SC server 100. It is appreciated that the personalized list may be generated by e.g., the searching methods disclosed above. The transmission of the personalized lists to the SC server 100 may be accomplished via any one of the methods disclosed above.

Per step 906, the SC server 100 monitors the bids. In other words, the SC server 100 is configured to receive and analyze information regarding the pendency of a sale. For each bid on item, the SC server 100 determines which bidder has entered the winning bid (step 908).

If the salvage source 120 has not won the bid on a particular item, at step 910, the SC server 100 accesses information describing the item which was for sale. At step 912, the descriptive information is utilized by a recommendation entity at the SC server 100 for comparison to other available items. In one embodiment, the recommendation entity comprises a computer program adapted to extract data regarding a first bid item and utilize the data to discover and report (i.e., recommend) to the salvage source 120 other similar items. Additionally the data may be used to report newly added salvaged vehicles as they enter the SC server 100.

The salvage source 120 is presented with recommendations (step 914) and if the user selects one of these options, the SC server 100 beings monitoring bids with respect to this item (step 916), such as via the methods disclosed above.

The salvage source 120 may also establish settings for the recommendation of alternatives, including limiting the number of recommended items (i.e. 10 per day) to be forward by at a preferences portion of the web interface.

### Escrow Services

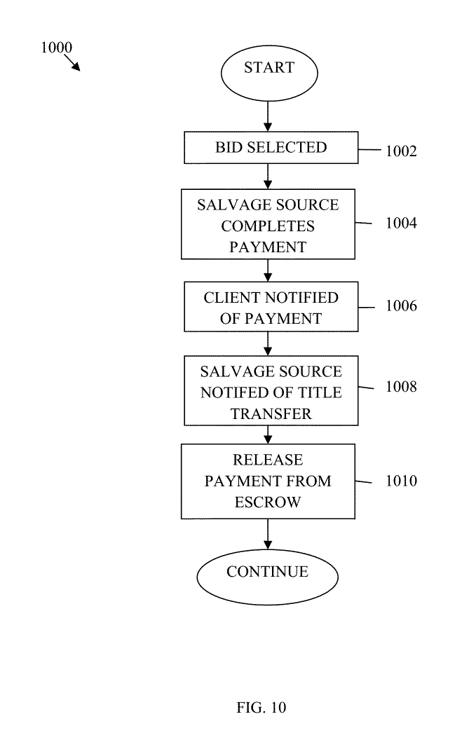

In yet another embodiment, an exemplary method 1000 of employing the SC server 100 of the present disclosure to process the purchase of an item is now described with respect to FIG. 10. As illustrated, at step 1002, the client selects an offer from among multiple bids to purchase the item. The client may choose the offer based on the best offer price, past experience with a particular salvage yard, grading of service provided, and other such parameters as best services, vehicle data, distance from the client. The SC server 100 then sends a notification to the salvage source 120 that was selected (i.e., the “winner”). The salvage source 120 takes possession of the item and notifies the SC server 100 that the item was picked up and of any advanced charges.

Per step 1004, the salvage source 120 completes the transaction. Completion of the transaction may, in one embodiment, include the payment of the item and any transaction fees. The payment of the item and any transaction fees are placed into escrow.

Per step 1006, the client is notified that payment has been received. In one embodiment, the client is instructed to begin title transfer of the item to the salvage source 120. The client notifies the SC server 100 when the title has been sent to the salvage source 120. In one variant, the client inputs a tracking number (e.g., FedEx, UPS, USPS, etc).

Per step 1008, the SC server 100 notifies the salvage source 120 that the title has been sent and is provided the tracking number.

Per step 1010, the SC server 100 releases the payment in escrow to the client upon receiving notification from the salvage source 120 that the title for the item has been received. In one variant, the SC server 100 facilitates the release of the payment in escrow by receiving notification from the salvage source 120 that title has been received. The SC server 100 then creates a billing record, which releases the payment in escrow to the client. In one variant, the billing record is stored in a profile for that particular salvage source 120. In another embodiment, the SC server 100 releases the payment in escrow to the client on a bi-monthly or monthly basis.

### Business Rules and Considerations—

Various exemplary business-related aspects of present disclosure are now described in detail.

In one embodiment, access to the various ones of the above-described features of the SC server 100 is featured as part of one or more optional subscription plans. For example, access to the time estimate and/or alarm/reminder feature may be charged at a premium over more basic services.

In another example, the salvage source 120 may be offered different reporting levels at different price ranges. It is also appreciated that the aforementioned services may be offered on per item inquired into with discounts for users reaching a particular threshold number. Alternatively, the salvage source 120 may purchase a subscription for access to the services on a per-bid, per-month, and/or per-year basis.

In another aspect of the disclosure, the aforementioned processor 104 running on the SC server 100 (one or more computer programs located thereon) includes a so-called “rules” engine. These rules may be fully integrated within various entities associated with the present disclosure. In effect, the rules engine comprises a supervisory entity which monitors and selectively controls the item information acquisition and delivery functions at a higher level, so as to implement desired operational or business rules. The rules engine can be considered an overlay of sorts to the remote content management and delivery algorithms.

For example, one rule implemented by the rules engine may comprise providing alerts/reminders to certain classes of subscribers or users in advance of others

Many other approaches and combinations are envisaged consistent with the disclosure, as will be recognized by those of ordinary skill when provided this disclosure.

It should be recognized that while the foregoing discussion of the various aspects of the disclosure has described specific sequences of steps necessary to perform the methods of the present disclosure, other sequences of steps may be used depending on the particular application. Specifically, additional steps may be added, and other steps deleted as being optional. Furthermore, the order of performance of certain steps may be permuted, and/or performed in parallel with other steps. Hence, the specific methods disclosed herein are merely exemplary of the broader methods of the disclosure.

It will be further appreciated that while certain steps and aspects of the various methods and apparatus described herein may be performed by a human being, the disclosed aspects and individual methods and apparatus are generally computerized/computer-implemented. Computerized apparatus and methods are necessary to fully implement these aspects for any number of reasons including, without limitation, commercial viability, practicality, and even feasibility (i.e., certain steps/processes simply cannot be performed by a human being in any viable fashion).

While the above detailed description has shown, described, and pointed out novel features of the disclosure as applied to various embodiments, it will be understood that various omissions, substitutions, and changes in the form and details of the device or process illustrated may be made by those skilled in the art without departing from the disclosure. The described embodiments are to be considered in all respects only illustrative and not restrictive. The scope of the disclosure is, therefore, indicated by the appended claims rather than the foregoing description. All changes that come within the meaning and range of equivalence of the claims are embraced within their scope.

What is claimed is:

1. An apparatus for enabling a real-time auction for salvaged vehicles, said apparatus comprising:
a first interface for communication with a vehicle information source, said vehicle information source comprising a seller of a salvaged vehicle;
a second interface for communication with a plurality of salvaged vehicle purchasers;
a storage apparatus; and
a processor in communication with said storage apparatus and configured to execute at least one computer program thereon, said computer program comprising a plurality of instructions which are configured to when executed by said processor:
receive a plurality of information relating to at least one salvaged vehicle for auction;
determine, based at least in part on a profile thereof, individual ones of said a plurality of salvage vehicle purchasers which are to receive a notification relating to said at least one salvaged vehicle for auction;
based on said determination, transmit said notification to said individual ones of said plurality of salvage vehicle purchasers;
receive a plurality of offers to purchase said at least one salvaged vehicle from respective ones of said individual ones of said plurality of salvage vehicle purchasers;
enable said vehicle information source to evaluate said plurality of offers and said respective ones of said individual ones of said plurality of salvage vehicle purchasers associated thereto via a user interface provided thereto; and
receive a selection of one of said plurality of salvage vehicle purchasers, said selection indicating acceptance of an offer to purchase said at least one salvaged vehicle by said one of said plurality of salvage vehicle purchasers.

2. The apparatus of claim 1, wherein said plurality of instructions are further configured to, when executed, based on said selection, transmit a first notice of said selection to said one of said plurality of salvage vehicle purchasers, said first notice indicating acceptance of said offer to purchase said at least one salvaged vehicle.

3. The apparatus of claim 2, wherein said first notice further comprises information about said at least one salvaged vehicle, said information indicating a location of said at least one salvaged vehicle.

4. The apparatus of claim 2, wherein said plurality of instructions are further configured to, when executed, receive a message from said one of said plurality of salvage vehicle purchasers, said message indicating said one of said plurality of salvage vehicle purchasers has picked up said at least one salvaged vehicle from said location.

5. The apparatus of claim 4, wherein said plurality of instructions are further configured to, when executed, based on said message, transmit a second notice to said seller of said salvaged vehicle, said second notice indicating that said salvaged vehicle has been picked up.

6. The apparatus of claim 2, wherein said plurality of instructions are further configured to, when executed, receive payment information from said one of said plurality of salvage vehicle purchasers.

7. The apparatus of claim 6, wherein said plurality of instructions are further configured to, when executed, place said payment information in an escrow account.

8. A method for enabling a real-time auction for salvaged vehicles, said method comprising:
receiving information relating to at least one salvaged vehicle for auction from a vehicle information source, said vehicle information source comprising a seller of a salvaged vehicle;
transmitting a notification relating to said at least one salvaged vehicle for auction to individual ones of a plurality of salvage vehicle purchasers based at least in part on a profile thereof;
receiving a plurality of offers to purchase said at least one salvaged vehicle from respective ones of said individual ones of said plurality of salvage vehicle purchasers; and
receiving a selection of one of said plurality of salvage vehicle purchasers, said selection indicating acceptance of an offer to purchase said at least one salvaged vehicle by said one of said plurality of salvage vehicle purchasers.

9. The method of claim 8, wherein said profile comprises preferences for said individual ones of said a plurality of salvage vehicle purchasers, said preferences comprising at least one of the following: (i) geographic parameters; (ii) vehicle types; and/or (iii) a vehicles cost.

10. The method of claim 8, wherein said profile comprises a subscription level for each of said individual ones of said a plurality of salvage vehicle purchasers.

11. The method of claim 8, wherein said information relating to at least one salvaged vehicle for auction comprises at least a claim descriptive information.

12. The method of claim 8, wherein said information relating to at least one salvaged vehicle for auction comprises at least a vehicle descriptive information.

13. The method of claim 8, further comprising based on said selection, transmitting a notice of said selection to said one of said plurality of salvage vehicle purchasers, said notice indicating acceptance of said offer to purchase said at least one salvaged vehicle.

14. The method of claim 13, further comprising receiving payment information from said one of said plurality of salvage vehicle purchasers for said at least one salvaged vehicle.

15. A non-transitory computer readable apparatus comprising a storage medium, said storage medium comprising at least one computer program having a plurality of instructions, said plurality of instructions configured to, when executed by a processing apparatus:
receive a plurality of information relating to at least one salvaged vehicle for auction;
identify, based at least in part on a profile thereof, individual ones of said a plurality of salvage vehicle purchasers which are to receive a notification relating to said at least one salvaged vehicle for auction;
transmit said notification to said identified individual ones of said plurality of salvage vehicle purchasers;
receive a plurality of offers to purchase said at least one salvaged vehicle from respective ones of said identified individual ones of said plurality of salvage vehicle purchasers;
enable said vehicle information source to evaluate said plurality of offers and said respective ones of said identified individual ones of said plurality of salvage vehicle purchasers associated thereto via a user interface; and
receive a selection of one of said plurality of salvage vehicle purchasers, said selection indicating acceptance of an offer to purchase said at least one salvaged vehicle by said one of said plurality of salvage vehicle purchasers.

16. The apparatus of claim 15, wherein said a plurality of information comprises at least a vehicle identification number (VIN) or an insurance claim number (ICN).

17. The apparatus of claim 16, wherein said plurality of instructions are further configured to, when executed:
transmit said VIN or said ICN to one or more vehicle information source; and
receive additional information different then said plurality of information, said addition information relating to at least one salvaged vehicle for auction.

18. The apparatus of claim 15, wherein said determination is further based on one or more factors, said one or more factors comprising at least (i) geographic parameters; (ii) vehicle types; and/or (iii) a vehicles cost.

19. The apparatus of claim 15, wherein said plurality of instructions are further configured to, when executed, based on said selection, transmit a notice of said selection to said one of said plurality of salvage vehicle purchasers, said notice indicating acceptance of said offer to purchase said at least one salvaged vehicle.

20. The apparatus of claim 19, wherein said plurality of instructions are further configured to, when executed, receiving a message from said one of said plurality of salvage vehicle purchasers, said message indicating a transfer of title for said at least one salvaged vehicle and a confirmation of payment for said at least one salvaged vehicle.
